(19) United States
(12) Patent Application Publication
(10) Pub. No.: US 2020/0326989 A1
(43) Pub. Date: Oct. 15, 2020

(54) BUILDING POOL-BASED M2M SERVICE LAYER THROUGH NFV

(71) Applicant: CONVIDA WIRELESS, LLC, Wilmington, DE (US)

(72) Inventors: Xu LI, Plainsboro, NJ (US); Quang LY, North Wales, PA (US); Rocco DI GIROLAMO, Laval (CA); Vinod Kumar CHOYI, Conshohocken, PA (US); Shamim Akbar RAHMAN, Cote St. Luc (CA); Zhuo CHEN, Claymont, DE (US); Chonggang WANG, Princeton, NJ (US)

(21) Appl. No.: 16/091,319

(22) PCT Filed: Apr. 5, 2017
(86) PCT No.: PCT/US2017/026136

§ 371 Date: Oct. 4, 2018

Related U.S. Application Data
(60) Provisional application No. 62/318,401, filed on Apr. 5, 2016.

(51) Int. Cl. G06F 9/50; H04L 29/08; G06F 9/455

(52) U.S. Cl. CPC G06F 9/5077; H04L 67/12; G06F 2009/45595; G06F 2009/45583; G06F 9/45558

(57) ABSTRACT

It is recognized herein that existing approaches to M2M/IoT networks do not realize Network Functions Virtualization (NFV). In particular, existing M2M service layers (e.g. oneM2M) are not built, managed, or operated in accordance with NFV practices. In an example embodiment, an M2M apparatus assigns various roles to various common service entities, such that common service functions can be pooled together with one another. The roles can be migrated among common service entities to ensure that the pools are managed and controlled efficiently. Further, pool members can exit and join one or more pools.

### CROSS REFERENCE TO RELATED APPLICATIONS

This application claims the benefit of priority to U.S. Provisional Patent Application No. 62/318,401, filed Apr. 5, 2016, the disclosure of which is incorporated by reference in its entirety.

### BACKGROUND

In general, Network Functions Virtualization (NFV) aims to transform how network operators architect networks via evolving standard IT virtualization technology. NFV may allow consolidation of various types of network equipment onto industry-standard, high-volume servers, switches, and storage, which can be located at Datacenters, Network Nodes, and end user premises. FIG. 1 shows an example of NFV as compared to an example typical (non-virtualized) network. Typically, NFV involves the implementation of network functions in software that can run on a range of industry standard server hardware, and that can be moved to, or instantiated in, various locations in the network as required, without the need for installation of new equipment.

Traditionally, in non-virtualized networks, network functions (NFs) are implemented as a combination of vendor specific software and hardware, which can be referred to generally as network nodes or network elements. In NFV, NFs can be realized through virtualization technology, which is described in detail below. Typically, NFV envisages the implementation of NFs as software-only instances, which are called Virtualized Network Functions (VNFs). A VNF can provide the same functional behavior and interfaces as the equivalent network function, but it may be deployed as a software instance on top of, for example, a Virtual Machine (VM).

The VNFs run over an NFV Infrastructure (e.g., physical computing resources, network resources, and storage resources). FIG. 2 shows an example implementation view of NFV, in which various NFs are deployed on multiple Virtualized Machines (VMs), and the VMs run on top of a hypervisor. A hypervisor may be a VM manager, which may be a program that allows multiple VMs to share a single hardware infrastructure. For example, a given hypervisor may help to abstract the underlying single physical machine as multiple VMs. Thus, NFV may help decouple software from hardware, achieve flexible deployment of network functions, and generally facilitate dynamic operations.

With respect to decoupling software from hardware, as the network element is no longer a collection of integrated hardware and software entities, the evolution of hardware and software may be independent of each other. This independence may enable the software to progress separately from the hardware, and visa-versa. Furthermore, for example, the detachment of software from hardware helps reassign and share the infrastructure resources (e.g., physical computing and storage resources). Therefore, hardware and software can perform different functions at various times. By way of further example, the decoupling of the functionality of the network function into instantiable software components provides greater flexibility to scale the actual VNF performance in a more dynamic way and with finer granularity, for instance, according to the actual traffic for which the network operator needs to provision capacity.

Thus, Network Functions Virtualization (NFV) explicitly targets at least two problems faced by network operators (NOs): 1) bringing costs in line with revenue growth expectations; and 2) improving service velocity. NFV can utilize resources more effectively and achieve reductions in operation expenditures (OpEX) and capital expenditures (CapEX) as compared to historical network approaches. For example, NOs can deploy network functions without having to send engineers to each site. In the meantime, NFV can help to support innovation by enabling services to be delivered via software on any industry-standard server hardware, for example, instead of using conventional functionality-specific network appliances. NFV technologies may help achieve network agility, programmability, and flexibility, for example, because NOs may quickly scale up or down (through virtualization) different services to address various changing demands. NFV may accelerate Time-to-Market. For example, NOs can reduce the time to deploy new networking services to support changing business requirements, seize new market opportunities, and improve return on investment of new services. Also, NOs may lower the risks associated with rolling out new services, and allow providers to easily test and evolve services to determine what best meets the needs of customers. Further still, through NFV, a service provider (SP) may improve and ensure the appropriate level of resilience to hardware and software failures.

Turning now to system implementations, the use of VNFs can pose additional challenges on the reliability of provided services. For example, a VNF instance does not typically have built-in reliability mechanisms on its host (e.g., a general purpose server). As a result, there may be risk factors, such as software failures at various levels including hypervisors, virtual machines, VNF instance, hardware failure, etc.

In order to achieve higher reliability, an architecture, which can be referred to as a VNF Pool architecture, can include a plurality of VNF instances having the same function that are grouped as a pool to provide their function. Conceptually, a Pool Manager (PM) may manage a VNF Pool for a certain type of NF. For example, the PM may select which VNF instances (pool members) are active or on standby, and the PM may interact with a Service Control Entity (SCE). An SCE refers to an entity that combines and orchestrates a set of network functions (e.g., VNFs) to build various network services. A benefit of using a VNF Pool is that reliability mechanisms, such as redundancy management, are achieved by the VNF Pool and thus are transparent to the SCE and external users of those VNF instances.

Referring to FIG. 3, an example VNF Pool architecture 300 is shown. The VNF pool architecture 300 includes an example service control entity 302, which is a logical entity of a service provider that determines how to combine and orchestrate network functions to build network services. The VNF Pool architecture 300 further includes a first example VNF (VNF A for a network function ‘A’) and a second example VNF (VNF B for a network function ‘B’). A given VNF, which may be a logical entity, may provide specific functional behavior and interfaces that are the same as an equivalent network function. Each VNF may be implemented as a software instance. Further, in accordance with the illustrated example, VNF A and VNF B may have different functions as compared to each other. As shown, VNF A includes a pool (VNF-A pool) and VNF B includes a pool (VNF-B Pool). In some cases, each type of VNF has a corresponding pool in which the pool members are software instances implemented the VNF. For example, as shown, the VNF-A Pool includes various instances implementing the VNF-A (e.g., VNF-A#1, etc.), and the VNF-B Pool includes various instances implementing the VNF-B (VNF-B#1, etc.). A VNF Pool Manager may be an entity that manages a VNF pool. Managing may include calling and scheduling pool members (described below). Managing may also include interacting with the SCE 302 to provide a given network function. As shown, by way of example, a first PM 306a manages the VNF pool 304a (which corresponds to VNF A), and a second PM 306b manages the VNF pool 304b (which corresponds to VNF B). A pool member may refer to a physical NF instance that joins the corresponding VNF pool and is managed by the PM. By way of example, a pool member may be a CSF or services capabilities software instance that is hosted or runs on a CSE. By way of further example, as shown in FIG. 3, software instances implementing VNF-A and VNF-B are pool members of the VNF-A Pool and the VNF-B Pool, respectively.

Turning now to datacenters and cloud computing generally, virtualization technology is often related to other concepts and topics, particularly for datacenters and cloud computing. In general, a datacenter is a facility used to house computer systems and associated components, such as telecommunications and storage systems. Datacenters generally include redundant or backup power supplies, redundant data communications connections, environmental controls (e.g., air conditioning, fire suppression), and various security devices. In contrast to datacenters, cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction. Cloud computing often has the following characteristics: 1) on-demand self-service; 2) broad network access; 3) resource pooling; 4) rapid elasticity; and 5) measured service. The major service models include Software as a Service (SaaS), Platform as a Service (PaaS), Infrastructure as a Service (IaaS), etc.

As described above, both types of computing systems (data centers and cloud computing) can store data as a physical unit, only a datacenter stores servers and other equipment. As such, cloud service providers (e.g., Google, Amazon, etc.) often use datacenters to house cloud services and cloud-based resources. A difference between a cloud and a datacenter is that a cloud is typically an off-premise form of computing on the Internet (although it has been proposed that private clouds can either be deployed on-premise or off-premise), whereas an organization often has an on-premise datacenter within the organization's local network. For example, when a company pursues cloud services provided by a third party (e.g., Google, Amazon, etc.), those services are provisioned by the service instances run in the datacenters built by the third party (such a case is referred to as off-premise service provisioning). Thus, the company may fully utilize the services with benefits such as “pay-as-you-go,” flexibility, and scalability. By comparison, the company may also choose to buy their own datacenter and run it locally. In other words, cloud computing may be thought of as a form of service provisioning, and datacenters may refer to a physical facility that can be used for realizing cloud-based services. Currently, cloud services are usually outsourced to third-party cloud providers who perform all updates and ongoing maintenance, and companies often also invest in their own datacenters that are typically run by an in-house IT department. The datacenters do not have the service scalability or flexibility features unless the company can invest their datacenter infrastructure on-demand.

The cloud computing paradigm has evolved to include more variations based on different needs as compared to earlier iterations. For example, currently end users and businesses are demanding more from the telecommunication industry for better user experience as compared to historical demands. A key transformation has been the ability to run and provide service directly at a network edge (instead of provisioning services in the core network) to apply the concepts of cloud computing, which is called Mobile-Edge Computing (MEC) as initialized by ETSI. In some cases, MEC can be seen as a cloud server (e.g., an M2M gateway) running at the edge of a mobile network and performing specific tasks (e.g., control functions) that could not be achieved with traditional centralized cloud deployment. FIG. 4 depicts an example of MEC. MEC may include various features, for example: 1) On-Premises computing; 2) Proximity; 3) Lower latency; and 4) Location awareness.

Virtualization is a key enabling technology for realizing cloud computing. Virtualization technologies may be categorized into different categories. For example, computing virtualization is a category that focuses on how to virtualize physical computing and storage resources (e.g., a server farm) to virtual machines based on a user's needs. Network virtualization is a category that focuses on how to slice the physical network substrate into multiple virtual networks, or how to stretch the network across multiple datacenter networks. By way of example, when a tenant needs to build a private virtualized network, network virtualization may be responsible for building the virtual links of this network on top of the physical substrate network infrastructure. In particular, when nodes or VMs in this virtualized network need to be migrated or moved into different places (e.g., across the datacenters), the network virtualization takes care of the maintenance of the virtualized network no matter how the underlying substrate network (e.g., physical links or paths) has been changed. NFV may be considered another category of virtualization, which may focus on how to use software appliances to replace proprietary hardware network appliances. In particular, NFV relates to computing virtualization because VNF instances can be deployed on top of VMs as shown above. In the meantime, the focus of NFV is to make the network become more agile, programmable, flexible, and scalable, in order to provide better network services, regardless of whether it is going to be applied on a physical network infrastructure or on a virtualized network through networking virtualization.

Referring now to FIG. 5, an example M2M system architecture 500 is shown. As shown, the M2M system 500 includes an M2M area network 502 that provides connectivity between M2M end devices 504 and M2M gateways (GWs) 506. Examples of M2M area networks include personal area networks that are based on technologies such as IEEE 802.15, Zigbee, Bluetooth, etc. The M2M end devices 504 can communicate with the M2M GW 506 and an M2M Server 508 via the M2M GW 506 and an access network or core network 512, which can enable interactions and/or interfacing with external networks and application systems 510 that are on the Internet for example. Many M2M devices 504 are resource-constrained entities that provide services, such as reporting sensory information (e.g., humidity, temperature, etc.) for example, or function as controllers (e.g., a light switch). M2M devices 504 may also be types of resource-rich appliances (e.g., home appliances with power supplies, cellphones, vehicles, other industry equipment, etc.).

Referring now to FIG. 6, an example protocol stack 600 is shown, in which the service layer 602 is above the application protocol layer 604, which is typical. The service layer 602 may provide value added services (e.g., device management, data management, etc.) to applications 601 or to another service layer. Thus, a service layer is often categorized as ‘middleware’ services.

With respect to service layers, by way of background, a service layer that targeted toward M2M/IoT nodes can be referred to as an M2M/IoT service layer. An example deployment of an M2M/IoT service layer instance within a network is shown in FIG. 7. In the illustrated example, a service layer instance 702 is a realization of a service layer. A plurality of service layer instances may be deployed on various network nodes (e.g., gateways and servers) for providing value-added services to network applications, device applications, and the network nodes themselves. Industry standard bodies (e.g., oneM2M) have been developing M2M/IoT service layers to address various challenges associated with integrating M2M/IoT types of devices and applications into existing networks. An M2M service layer can provide applications and devices access to a collection of M2M-oriented service capabilities that are supported by the service layer. Examples of such capabilities include security, charging, data management, device management, discovery, provisioning, and connectivity management. These capabilities can be made available to applications via Application Program Interfaces (APIs), which may make use of message primitives defined by the M2M service layer.

Turning now to oneM2M, by way of background, a goal of oneM2M is to develop technical specifications that address the need for a common service layer that can be readily embedded within hardware apparatuses and software modules to support a wide variety of devices in the field. The oneM2M common service layer supports a set of Common Service Functions (CSFs) (service capabilities) as shown by an example oneM2M architecture 800 depicted in FIG. 8. An instantiation of a set of one or more particular types of CSFs is referred to as a Common Services Entity (CSE), which can be hosted on different types of network nodes (e.g., Infrastructure Node, Middle Node, and Application-Specific Node). CSEs are termed IN-CSE, MN-CSE and ASN-CSE respectively as defined in oneM2M Functional Architecture.

The standards body oneM2M initially was developing the service layer compliant to the Resource-Oriented Architecture (ROA) design principle, in the sense that within the oneM2M ROA RESTful architecture that is shown in FIG. 9, different resources are defined. A resource is a uniquely addressable element in the architecture. A resource can be manipulated via RESTful methods such as Create, Retrieve, Update, and Delete. Resources are addressable using a Uniform Resource Identifiers (URIs). A resource may contain child resource(s) and attribute(s).

Recently, oneM2M has begun developing an M2M Service Component Architecture (shown in FIG. 10), to consider legacy deployments that are not RESTful based. This architecture is primarily suitable for the infrastructure domain in which the CSE is viewed as a set of service components. The architecture shown in FIG. 10 re-uses the existing service layer architecture shown in FIG. 9, but within the service layer it contains various M2M services, and multiple services can be grouped into service components. In addition to existing reference points, the architecture shown in FIG. 10 introduces the inter-service reference point Msc. Communication between M2M Service Components (passing over the Msc reference point) utilizes a web service approach, which may be the most popular technology for building Service-Oriented Architecture (SOA)-based software systems.

As discussed above, NFV has various benefits for providing better network services. Existing approaches to M2M/IoT networks, however, do not realize NFV.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

It is recognized herein that existing approaches to M2M/IoT networks do not realize Network Functions Virtualization (NFV). In particular, existing M2M service layers (e.g. oneM2M) are not built, managed, or operated in accordance with NFV practices. Therefore, benefits of NFV are not realized in the existing service layer.

In an example embodiment, an M2M node sends a request to a plurality of common service entities. The request may query a current capacity of each common service entity (CSE) and whether each CSE is willing to be a common services function (CSF) pool controller (CPC) or a CSF pool manager (CPM). In response to the request, the node receives a plurality of responses from the plurality of common service entities, and each response includes information related to whether a respective CSE can be the CPC or CPM. The node, which may be a service provider, evaluates the information from each response to select at least one CPC and at least one CPM from the plurality of common service entities. The node generates a role profile for the at least one CPC, wherein the role profile comprises at least one of a minimum performance requirement for a virtual machine of the CPC, a preferred performance time for the virtual machine of the CPC, a role migration strategy, and a role software update schedule. The node may similarly generate a role profile for the CPM. The respective role profiles may be sent to the CSE selected to be the CPM and to the CSE selected to be the CPC. The node may further deploy a respective software package to the CSE selected to be the CPM and to the CSE selected to be the CPC, wherein the respective package enables each CSE to configure itself to be the CPC or CPM. In another example, the node may send a respective indication to the CSE selected to the CPM and to the CSE selected to be the CPC, wherein the respective indication enables each CSE to configure itself be the CPC or CPM.

In another example embodiment, a pool is managed by a CPM such that pool members can join the pool and be deleted from the pool. Pool members can be CSF software instances that run on different common service entities. For example, an M2M node may receive a notice from a common service function (CSF) pool controller (CPC). The notice may indicate that one or more CSF instances of a common service entity (CSE) are applying to join a pool managed by the node. When the one or more CSF instances are approved to join the pool, the node may add the one or more CSF instances to an inventory list for future use. The node may send a message to the CSE, and the message may indicate that the one or more CSF instances are being managed by the node. In response to the message that is sent to the CSE, the node may receive an acknowledgment message, from the CSE, wherein the acknowledgement message comprises performance data associated with the CSE. The node may update the inventory list to include the performance data associated with the CSE, such that the performance data can be referred to when the node intends to assign or call the one or more CSF instances for processing a service layer request. Furthermore, in an example, the node may send a delete notice to the CSE. The delete notice may indicate that the one or more CSF instances are being deleted from the pool. The delete notice may be sent based on one or more historical performance statistics of the CSE. The node may receive a delete acknowledgement from the CSE, and the delete acknowledgment may indicate that the CSE is aware that the one or more CSF instances are being deleted from the pool. Alternatively, or additionally, the node may receive a delete notice from the CSE. The delete notice may indicate that the one or more CSF instances are requesting to quit the pool. The delete notice may be sent based on a determination of the CSE that the one or more CSF instances cannot support processing assigned to it. Accordingly, the node may delete the one or more CSF instances from the pool.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1 is diagram that illustrates concepts associated with Network Functions Virtualization (NFV);

FIG. 2 is an example implementation view of NFV;

FIG. 3 is a block diagram that depicts an example of a Virtualized Network Function (VNF) architecture;

FIG. 4 is a diagram that illustrates an example of mobile edge computing (MEC);

FIG. 5 is a system diagram that depicts an example machine-to-machine (M2M) network architecture and services;

FIG. 6 shows an example protocol stack that supports a service layer;

FIG. 7 is a system diagram that depicts an example of an M2M or Internet of Things (IoT) service layer that is deployed within a network;

FIG. 8 shows common service functions (CSFs) in the oneM2M service layer;

FIG. 9 is a block diagram that depicts the oneM2M service layer resource-oriented architecture;

FIG. 10 is a block diagram that depicts the oneM2M services component architecture;

FIG. 11 depicts an example message flow that is defined in oneM2M;

FIG. 12 illustrates an example use case in which a service layer does not apply NFV;

FIG. 13 is a call flow that depicts an example message exchange in accordance with an example embodiment;

FIG. 14 depicts an example functional architecture for a pool-based M2M service layer in accordance with an example embodiment;

FIG. 15 depicts example tasks for realizing the pool-based service layer in accordance with an example embodiment;

FIG. 16 is a call flow that depicts an example candidate selection process in accordance with an example embodiment;

FIG. 17 is a call flow that depicts an example role selection process in accordance with an example embodiment;

FIG. 18 is a call flow that depicts an example role migration process in accordance with an example embodiment;

FIG. 19 is a call flow that depicts an example role linking process in accordance with an example embodiment;

FIG. 20 is a call flow that depicts an instance of a common service function (CSF) joining a VNF pool in accordance with an example embodiment;

FIG. 21 is a call flow that depicts an instance of a CSF leaving a VNF pool in accordance with an example embodiment;

FIG. 22 shows a VNF pool enabler service (VPES) in the oneM2M service layer in accordance with an example embodiment;

FIG. 23 shows an example oneM2M resource for a CSF Pool Controller (CPC) according to an example embodiment;

FIG. 24 shows an example oneM2M resource for a CSF Pool Manager (CPM) according to an example embodiment;

FIG. 25 is a call flow that shows oneM2M pooling in accordance with an example embodiment;

FIG. 26 shows an example graphical user interface that is associated with a system in accordance with an example embodiment;

FIG. 27 shows an example graphical user interface that is associated with an example CSF pool in accordance with an example embodiment;

FIG. 28A is a system diagram of an example machine-to-machine (M2M) or Internet of Things (IoT) communication system in which one or more disclosed embodiments may be implemented;

FIG. 28B is a system diagram of an example architecture that may be used within the M2M/IoT communications system illustrated in FIG. 28A;

FIG. 28C is a system diagram of an example M2M/IoT terminal or gateway device that may be used within the communications system illustrated in FIG. 28A; and

FIG. 28D is a block diagram of an example computing system in which aspects of the communication system of FIG. 28A may be embodied.

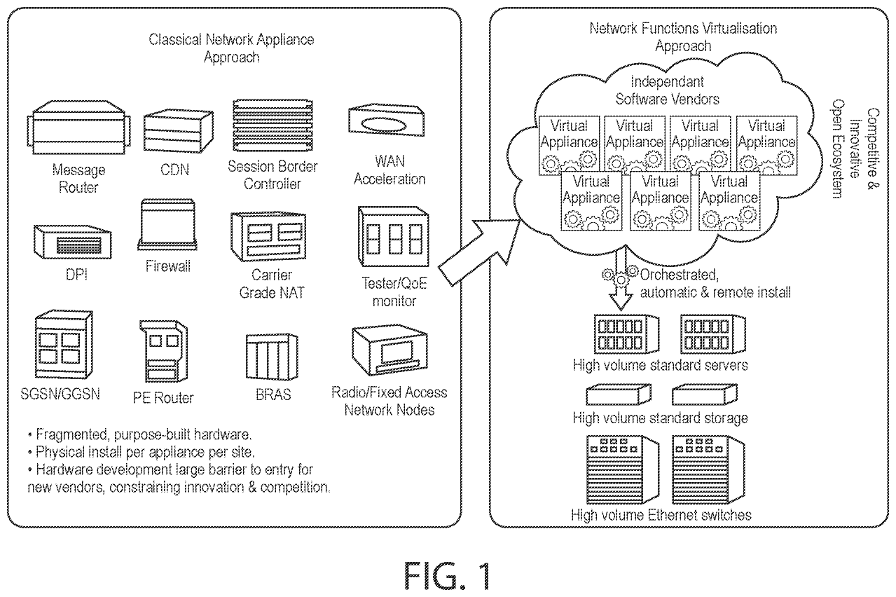

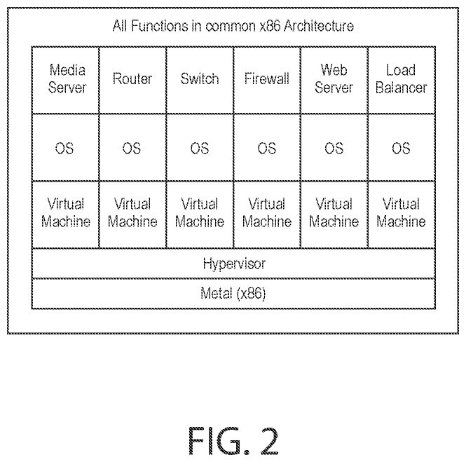

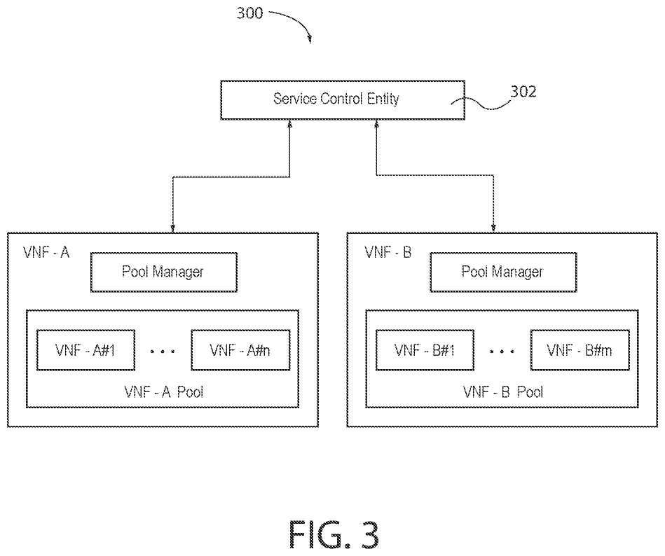

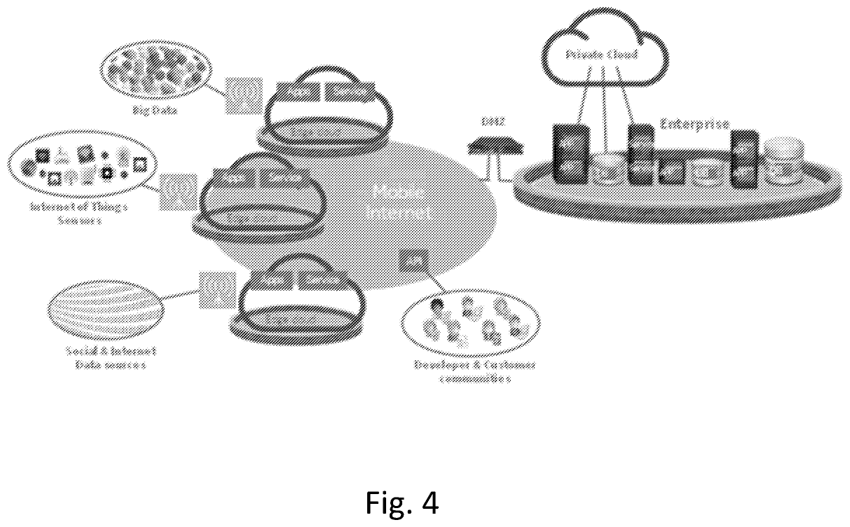

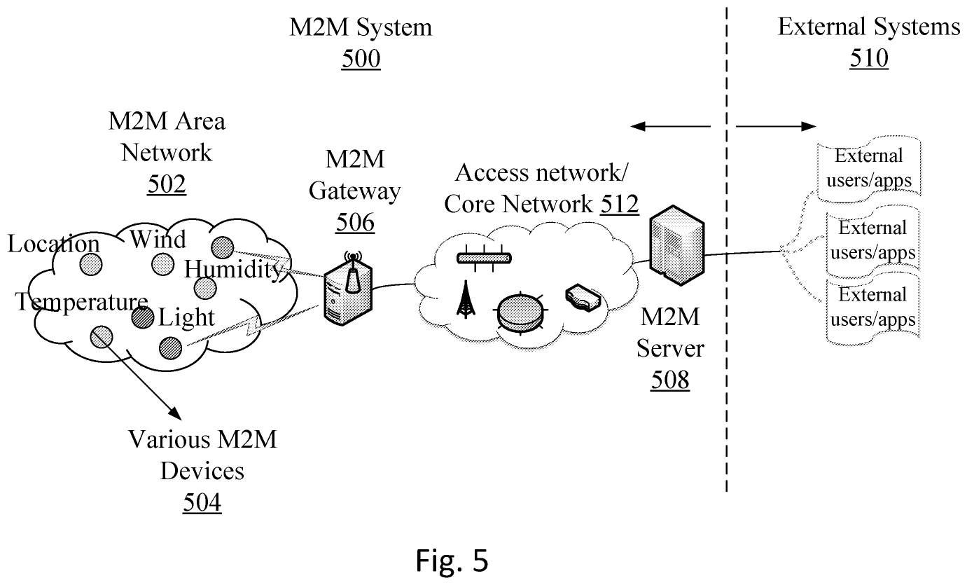

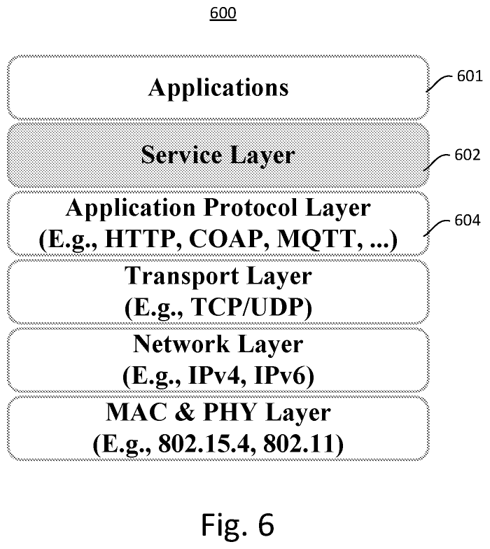

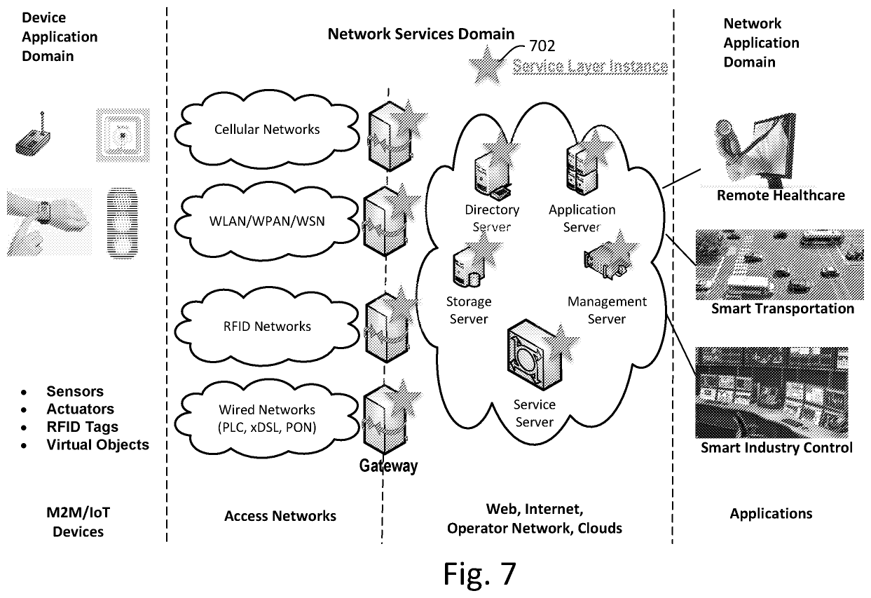

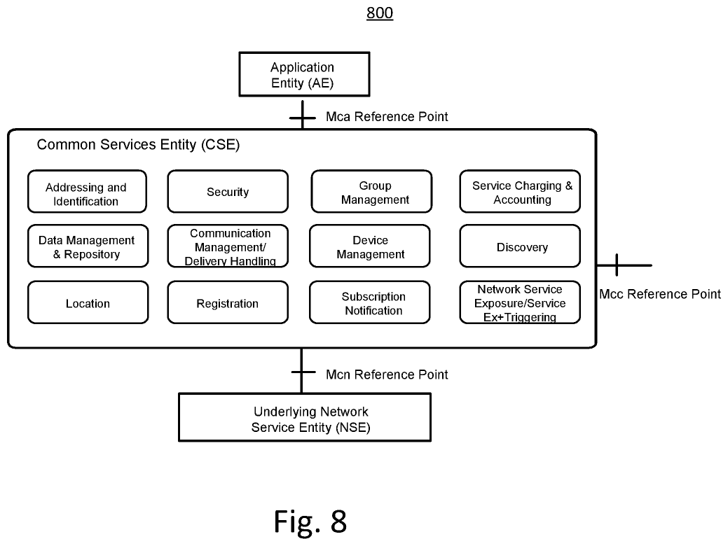

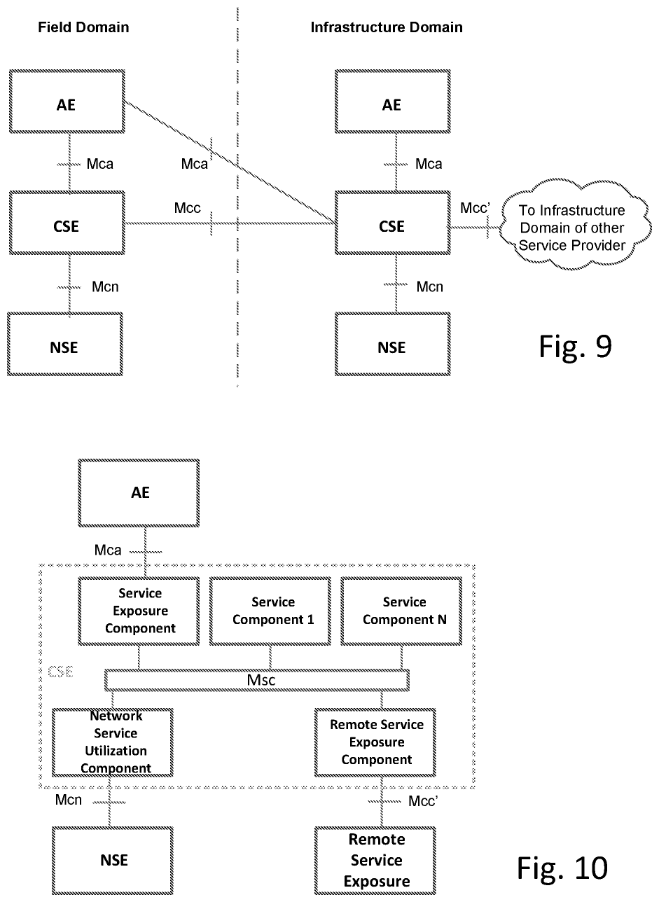

### DETAILED DESCRIPTION OF ILLUSTRATIVE EMBODIMENTS

It is recognized herein that existing approaches to M2M/IoT networks do not realize Network Functions Virtualization (NFV). In particular, existing M2M service layers (e.g. oneM2M) are not built, managed, or operated in accordance with NFV practices. Therefore, benefits of NFV are not realized in the existing service layer.

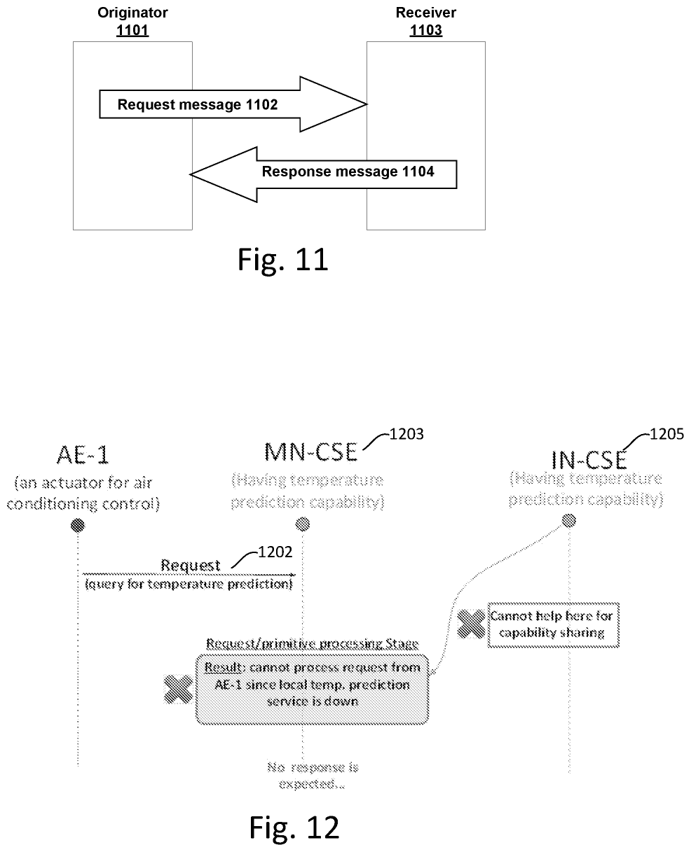

As mentioned above, the oneM2M common service layer supports a set of common service functions (CSFs), and an instantiation of a set of one or more particular types of CSFs is referred to as a common services entity (CSE). Referring to FIG. 11, procedures involving common service entities (CSEs) and Application Entities (AEs) are driven by the exchange of messages across reference points, which are based on the use of Request and Response messages. In particular, upon receiving a request message 1102 from an originator 1101, a receiver 1103 of the request 1102 calls certain services or CSF instances that are implemented or running on the receiver 1103 to process the request 1192, and send back a response message 1104 to the originator 1101.

Turning now to a specific example use case, referring to FIG. 12, an Application Entity (AE-1), which is an actuator for air conditioning control, sends a request (at 1202) to a Middle Node CSE (MN-CSE) 1203 with the URI targeted for the MN-CSE 1203. In accordance with the example, the request at 1202 originally is supposed to be processed by a data analytics service running on the MN-CSE 1203 in order to get a temperature prediction. For the time being, in accordance with the example use case, it is assumed that the capability of the MN-CSE 1203 cannot be dynamically scaled up or down. If, for example, the MN-CSE 1203 is overloaded due to too many requests that are received from M2M area networks, or the data analytics service on the MN-CSE 1203 is unresponsive or otherwise unavailable, the request from AE-1 might not be processed in time. It is noted herein that a solution of always over-provisioning extra capacity on a CSE might not work well due to poor flexibility and energy efficiency. Continuing with the example use case depicted in FIG. 12, the same data analytics service instance that is running on the MN-CSE 1203 is running on other nodes, for instance an infrastructure node CSE (IN-CSE) node 1205. In accordance with the example use case, the MN-CSE 1203, however, is not able to dynamically invoke the service instance on the IN-CSE 1205 (or any other nodes) to process the request received at 1202.

The use case relative to FIG. 12 is different from a case in which the MN-CSE 1203 simply forwards the request to the IN-CSE 1205. In a forwarding case, AE-1 specifically sets the target URI for the IN-CSE 1205, and not the MN-CSE 1203 as in the example use case described with reference to FIG. 12. With respect to a capability sharing scenario described below, the AE-1 does not have to be aware that the IN-CSE 1205 will handle its request.

The use case depicted in FIG. 12 is one example, of a plurality, which demonstrates limitations of current approaches to building a service layer. For example, service layer capabilities (in terms of CSF) may be prevented from being utilized efficiently between different CSEs across M2M/IoT networks. In accordance with an example embodiment described below, a paradigm for building and managing M2M service layers is described that utilizes NFV technology. For example, a paradigm for building pool-based service layers through NFV is disclosed below. It will be appreciated that while much of the below description includes explanatory examples in the context of oneM2M to illustrate various embodiments, the embodiments are not limited to oneM2M. For example, the embodiments described can be implemented with other service layers as desired.

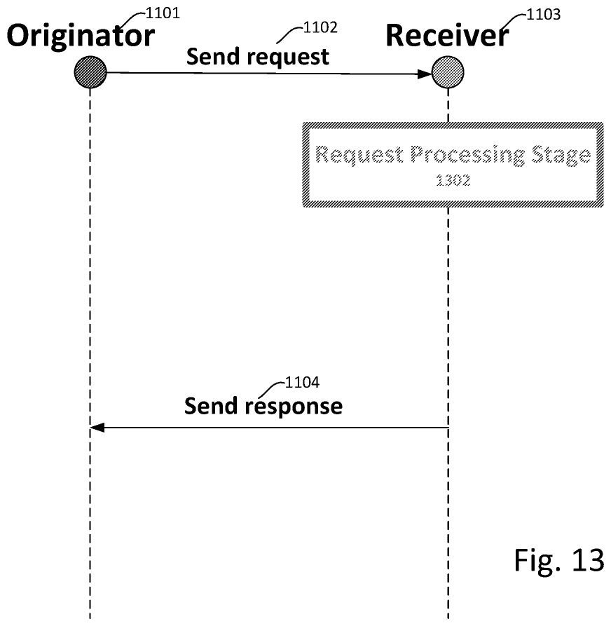

Referring now to FIG. 13, an example oneM2M system is shown. As shown in FIG. 13, for a oneM2M common service layer, the procedures involving CSEs and AEs are driven by the exchange of messages across reference points, and the general flow is based on the use of Request and Response messages as described with reference to FIG. 11. In particular, as shown in FIG. 13 upon receiving a request from the originator 1101, the receiver 1103 performs a request processing stage at 1302. The request process stage at 1302 may include processing the request and obtaining a processed result. The processed result may be sent back to the originator in the response message, at 1104.

During the request processing stage at 1302, as further described below, one or more different service capabilities or CSF software instances may be called for processing the request. In accordance with current oneM2M practices, the request processing at 1302 is within a CSE. The CSE may be realized by using a centralized cluster where certain internal optimizations, such as load balancing for example, are supported. In embodiments described below, however, a CSF or a service capability may be shared across different CSE's. Referring to FIG. 13, it is described below how a service layer request (at 1102) that is received by a given CSE (e.g., receiver 1103) can be processed at 1302 in implementations in which NFV is used for building the service layer, and CSF or service capability is shared between CSE's. In an embodiment, CFS's or service capabilities (e.g., software instances), which are hosted or running on different CSE's, are dynamically and collaboratively leveraged to process the request at 1302.

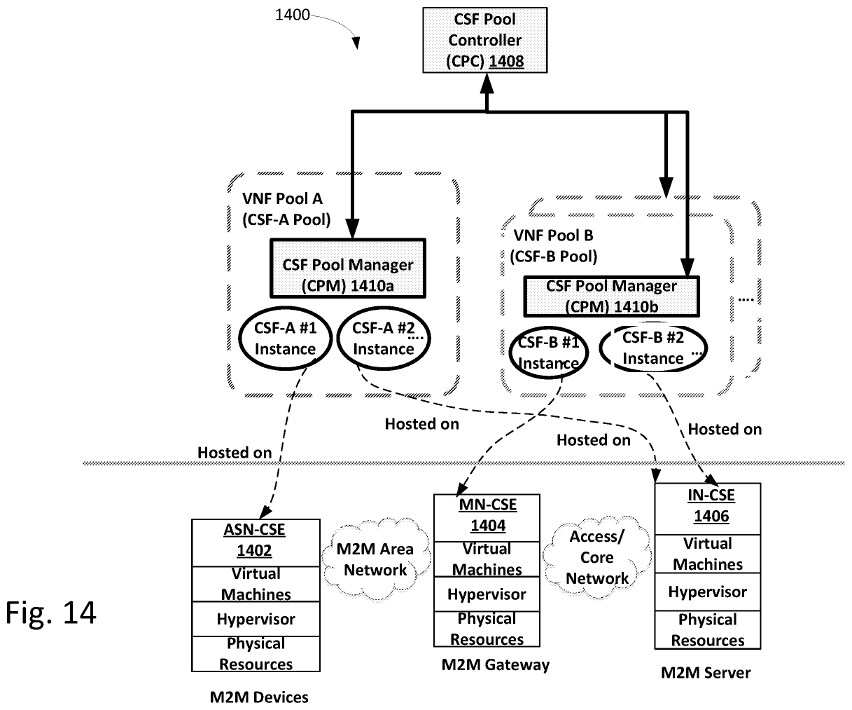

Referring now to FIG. 14, an example architecture 1400 includes a pool-based service layer that is implemented via NFV. Using NFV, physical resources of M2M/IoT nodes may be virtualized, by a hypervisor, as virtual machines (VMs). Accordingly, different network function software instances (e.g., CSFs or services capabilities) that run on an M2M node can construct a given CSE (e.g., ASN-CSE 1402, MN-CSE 1404, or IN-CSE 1406) by being dynamically deployed/run/uninstalled from the M2M node, based on needs. It will be understood that the ASN-CSE 1402, MN-CSE 1404, and the IN-CSE 1406 may each be referred to generally as an M2M node. In particular, for example, as described below, CSF or service capability software instances that are hosted on different CSEs can join corresponding VNF pools and can be managed by the CSF Pool Managers (CPMs) of those VNF pools, which can also referred to as CSF pools herein. A CSF pool generally refers to a plurality of CSF instances that provide the same network function. A CSF pool member generally refers to a physical CSF instance that joins a CSF pool and is managed by the pool's CPM. The CPM generally refers to a logical entity that manages (e.g., (managing/calling/scheduling pool members) and interacts with a CSF pool controller (CPC) to provide CSF instances.

In designing the embodiments described herein, it is recognized herein that nodes in M2M/IoT systems may be resource constrained, such that a service layer request might not be timely processed due to, for example, limited processing capability of the receiver CSE. Thus, the receiver CSE may ask for help from peers. In particular, the pooling mechanisms described herein may allow CSF instances to be shared and dynamically provisioned in an on-demand manner. It is further recognized herein that M2M nodes often have sleeping schedules for energy efficiency purposes. Therefore, when a given CSF instance becomes unavailable, for example due to periodic sleeping, an immediate back-up CSF instance can be provisioned, which is supported by the pooling mechanism in accordance with an example embodiment.

Referring again to FIG. 14, the architecture 1400 can include one or more CSF Pool Controllers (CPCs), for instance a CSF Pool Controller (CPC) 1408, and one or more CSF Pool Managers (CPMs), for instance a first CPM 1410a and a second CPM 1410b. Although two pools (VNF Pool A and VNF Pool B) are shown for exemplary purposes, it will be understood that the CPC 1408 may control any number of pools as desired. As shown in FIG. 14, the CPC 1408 and CPMs 1410a and 1410b may be logical functions. Accordingly, the CPC and CPM functions may be performed by certain CSEs in the network. It will be understood that, unless otherwise specified, the terms CSE node and M2M node may be used interchangeably herein. The pools (VNF Pool A and VNF Pool B) may be logical pools in the sense that the CSF software instances in those pools may be physically distributed across the M2M network. By way of example, as shown, the VNF Pool A (which may also be referred to as the CSF-A Pool) includes a physical software instance CSF-A#1 that is hosted on the ASN-CSE 1402 in the M2M area network. The CSF-A Pool further includes a physical software instance CSF-A#2 that is hosted on IN-CSE 1406 side. As used herein, a CPC may generally refer to a logical entity of the service provider that determines how to combine and orchestrate various CSFs.

In an example embodiment, a given service layer request that is received by a receiver CSE can be processed locally or the receiver CSE may contact the CPC (which may be another CSE that is currently taking the role of CPC), and the CPC may ask appropriate CPMs to process the request (e.g., by calling different CSF instances from the pool). The CPC may return the processed result back to the receiver CSE, and the CSE may send the response message back to the originator of the request. The request processing details may be transparent or hidden from the originator of the request.

As described herein, a given CSE may assume various roles that might not be exclusive of one another. For example, a CSE may be a service layer request originator, as described in the oneM2M service layer context. A CSE may be a service layer request receiver that may also be a VNF Pool “CSF resource consumer” if the CSE contacts the CPC for processing its received requests by using CSF instances provided by VNF pools. A given CSE may be a VNF Pool “CSF resource provider,” for example, if the CSE is running one or more CSF instances, and if the CSE is willing to make those CSF instances join corresponding VNF pools that are managed by CPMs.

In an example embodiment, as described in detail below, a service provider (SP) can configure a given M2M network in which multiple CSEs have been deployed to realize the pool-based architecture described with reference to FIG. 14. For example, the SP can assign logical roles (e.g., CPC, CPM, etc.) to certain CSEs. Further, because different types of CSF instances can join VNF pools and cab be managed by corresponding CPMs, specific procedures or mechanisms are described below that support pool management.

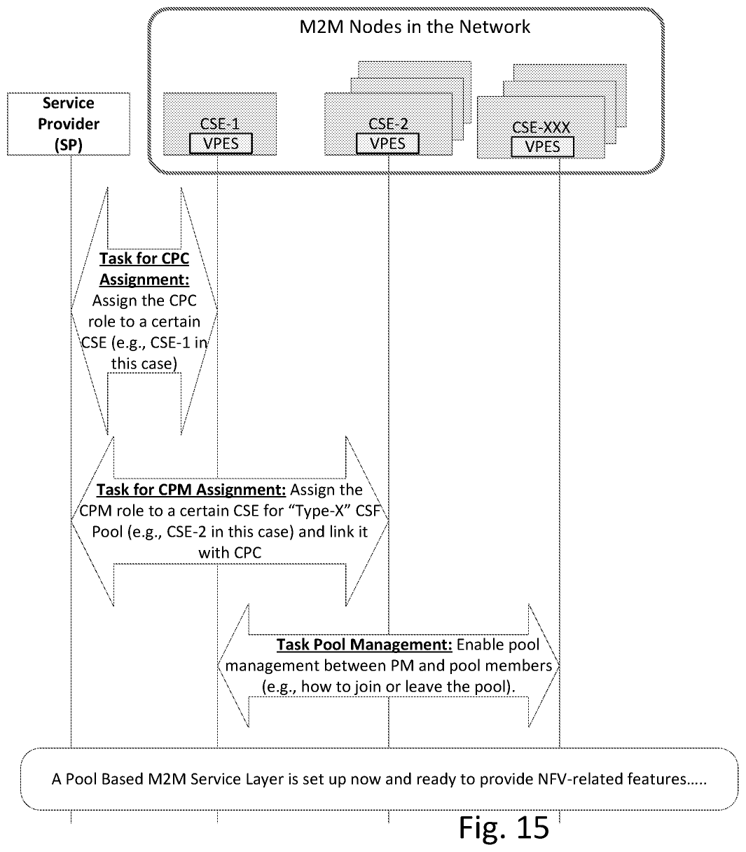

In particular, for example, a new service of a CSE is disclosed herein that is referred to as a VNF Pool Enabler Service (VPES). The VPES may help build a VNF Pool based Service layer that is described herein. Using the VPES, tasks related to service layer setup, deployment, and pool management are performed, as illustrated in FIG. 15.

Referring to FIG. 15, the CPC roles are assigned. In accordance with the illustrated example, the SP assigns a CSE-1 to take the role of the CPC with the support of the VPES. In some cases, the CPC is the portal of the VNF Pool-based system in the sense that if a receiver CSE intends to process a service layer request by using CSF software instances in one or more VNF pools, the receiver CSE will first contact the CPC. As shown, the SP may assign a CSE (CSE-2) to take the role of the CPM (with the support of VPES), and link the CPM with the CSE-1 that was assigned to perform the role of CPC. Such a task for CPM assignment may be executed multiple times because there may be multiple types of CSFs, and each of the types of CSFs may require a CPM for managing its corresponding pool. Referring now to the illustrated task for pool management, a CPM may perform certain mechanisms to enable CSF instances to join or leave the pool. Once the illustrated tasks have been carried out, a pool-based service layer can be implemented in terms of system-wide dynamic CSF resource pooling and sharing.

In an alternative example, the SP can preconfigure CSE with certain roles before deployment, such that the tasks illustrated in FIG. 15 are not performed. Such an implementation may that pre-configuration is performed before deployment. As mentioned above, however, there are often various dynamic changes in M2M/IoT systems. For example, M2M nodes may become unavailable when they sleep. Accordingly, certain tasks may need to be performed by the SP in order to dynamically set up or configure the network after deployment. In addition, those tasks may need to be tailored to highly distributed M2M/IoT networks, as described below.

The task for CPC assignment will now be discussed in further detail. M2M/IoT networks or systems often experience various dynamic changes that are different from the application scenario in a cloud or datacenters. For example, M2M nodes may become unavailable due to periodic sleeping that conserves energy. Further, M2M nodes may have more mobility characteristics as compared to the static deployment of computing nodes in clouds or datacenters. In addition, in many cases, M2M/IoT nodes are resource constrained such that it is necessary to consider the resource consumption aspect when assigning a role to a certain CSE. Therefore, it is recognized herein that it might not be a trivial task to assign a Service Control Entity (SCE) role to a qualified CSE in M2M/IoT networks.

In some cases, to address various requirements related to M2M/IoT systems, a Candidate Selection Process (CSP), a Role Assignment Process (RAP), and a Role Migration Process (RMP) may be performed to accomplish the task for CPC assignment. Regarding an example CSP, in a distributed M2M network, M2M nodes may have dynamic capacity status due to various real-time processing. Therefore, a CSP may evaluate a number of candidate CSEs based on their current capacities, and the best CSE may be selected to assume the CPC role.

Regarding an example RAP, in some cases, once a certain CSE has been selected during the CSP process, the SP may conduct certain operations to assign the role to the selected CSE. Regarding an example RMP, in some cases, in view of changes or events that occur in M2M/IoT networks, a selected CSE may, at some point, no longer be able to act as a CPC. Therefore, the CPC role may be migrated dynamically between different CSEs.

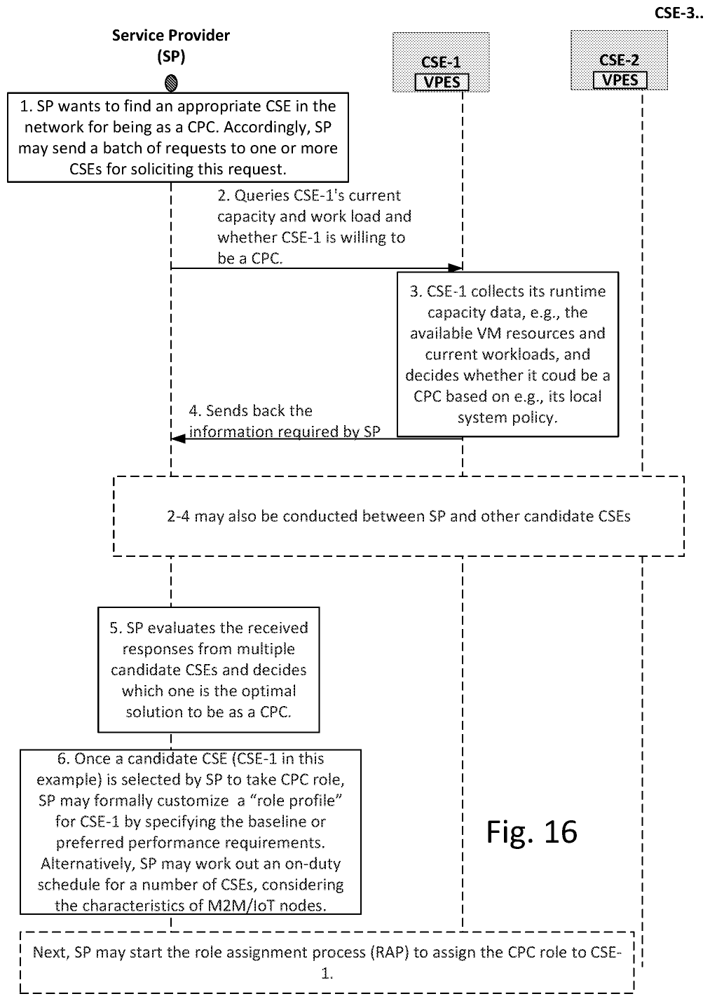

Referring now generally to FIGS. 16-21, example methods are performed in a system (or network) that includes a SP, and a plurality of CSEs. For example, the CSEs may include a CSE-1 that includes a VPES, a CSE-2 that includes a VPES and a CSE-3 that includes a VPES. It will be appreciated that the example system is simplified to facilitate description of the disclosed subject matter and is not intended to limit the scope of this disclosure. Other devices, systems, and configurations may be used to implement the embodiments disclosed herein in addition to, or instead of, a system such as the network shown in FIGS. 16-21, and all such embodiments are contemplated as within the scope of the present disclosure.

Referring in particular to FIG. 16, an example candidate selection process (CSP) is shown. At 1, in accordance with the illustrated example, it is assumed that the SP already checked that there is no CSE acting as the CPC in the system. At 1, the SP wants to find an appropriate CSE in the network that can perform the role of a CPC. Accordingly, the SP, for instance an administrative application run by the SP, may send a batch of requests to one or more CSEs. Thus, the SP may send a request to a plurality of common service entities. As shown, the CSE-1 is an example of one of the CSEs that receives the request and performs operations associated with the request. In some cases, because the CSC may assume a critical role in the architecture described herein, the SP only sends the requests to trusted CSEs. In doing so, the SP may collect various information from select trusted CSEs. The information may include, for example and without limitation, information associated with a node's performance, information associated with the availability of a node, and security related information. With respect to performance, for example, the SP may require that a powerful node acts as the CPC. Thus, the SP may select an M2M server or gateway that has powerful edge computing capabilities. With respect to availability of a node, the SP may select a CSE that is generally available for the CPC role. By way of example, the SP may determine that an M2M server or gateway is most likely to be available, and therefore an M2M server or gateway may be a first option by default. It will be understood that other nodes besides an M2M server or gateway may alternatively be selected as the CPC. With respect to security information, the SP may select a CSE that has an appropriate security mechanism to ensure that the system can be running without security issues and threats. For sending requests, the SP may use the existing oneM2M group operation to first define a group that includes the trusted CSEs. Thus, once the SP needs to find an appropriate CSE to be the CPC, the SP can conduct group communication operations through the defined <group> resource to send the request to those CSEs.

Still referring to FIG. 16, at 2, in accordance with the illustrated example, the SP queries CSE-1's current performance capacity and queries whether CSE-1 is willing to be a CPC. In an example, the request may query a current capacity of each CSE and whether each CSE is willing to be the CPC. In particular, the VPES of the CSE-1 may answer the queries. In some cases, NFV technology is utilized, and thus the usable computing/storage resources can be described in terms of available VM resources. The message sent at 2 can include various data fields, such as, by way of example and without limitation:
Sender ID (s_id), which identifies the identity of the sender so that the receiver is informed that the message was sent from the SP.
Message Type (m_t): The message type may indicate the purpose of the request. For example, the receiver CSE may know that SP is asking whether it is willing to be a CPC from the message type.
Time Duration (t_d): In some cases, the SP want a CPC for a given time period, which may be indicated by the time duration parameter.
Types of Performance Data to Be Queried (p_list): The SP may indicate to the receiver which types of performance data the SP is interested in, so that the receiver CSE does not have to return too much performance data that may not be needed by the SP. By way of example, a list of data fields may specify performance types, such as CPU, RAM, storage, etc.
Connectivity (con): The SP may also be interested in the connectivity information of the receiver CSE, for example, in order to decide whether it is a good candidate to be a CPC. For example, a CSE should not act as a CPC if it has poor connectivity with other nodes in the networks because the CPC may conduct coordination and cooperation operations among multiple nodes in the network.

At 3, in accordance with the illustrated example, the VPES of CSE-1 collects its runtime capacity data by interacting with its OS or hypervisor (e.g., the available VM resources). The VPES of CSE-1 may also determine whether it could act as a CPC based on its local system policy. In some cases, if a certain CSE has sufficient VM resources to act as a CPC, it may need to make sure that the local system policies allow it to do so. For example, some nodes may be configured by users such that the VM resources on a given node can only be utilized by specific applications or users. Accordingly, those nodes might not be able to indicate to the SP that they are willing to act as a CPC. Similarly, some security related policies may also lead to the same situation in which a node cannot act as a CPC. At 4, as shown, the CSE-1 sends back the above-mentioned information required by the SP in a response. The message at 4 may contain various data fields, such as, for example and without limitation:
Receiver ID (r_id): The identity of the message receiver informs the SP that the response is from a candidate CSE.
Response Type (r_t): This data field may inform the SP whether the receiver CSE is willing to be a CPC.
Detailed Performance Data (dp_list): The receiver CSE may return a list of performance data to SP, e.g., based on the SP's interest as specified in the request message. For example, performance data may include, without limitation: CPU supported by the VM, RAM supported by this VM, Storage support by this VM, SLA (Service Level Agreement) supported by this VM, Operating system run on this VM, Sleep Schedule or available time period to be as CPC, and the like. Compared to the previous information exposed to the CPC at 1, the data here include more runtime data describing a current available VM.
Topology information (t_i): The receiver CSE may inform the SP of its topology information, which may indicate its connectivity status.
   As described above, because there may be multiple candidate CSEs (in addition to CSE-1) in the network, steps 2-4 may be conducted between SP and other candidate CSEs. Thus, in response to the request, the SP may receive a plurality of responses from the plurality of common service entities, and each response may include information related to whether a respective CSE can be a common service function (CSF) pool controller (CPC).

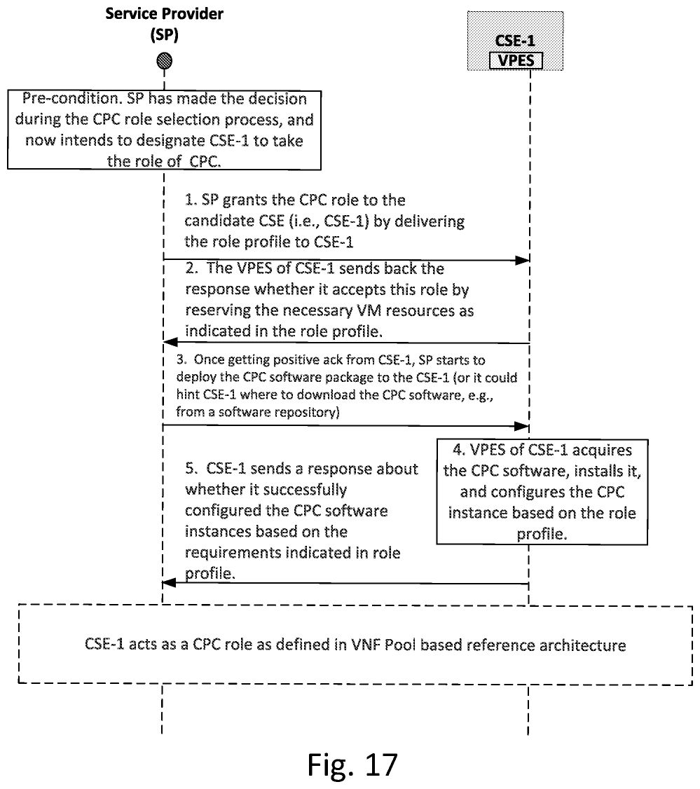

Still referring to FIG. 16, in accordance with the illustrated example, at 5, once the SP collects the information from the candidate CSEs, the SP evaluates the candidate CSE using various criteria and determines which CSE is the best to assume the role as the CPC. For example, the SP may determine that the best CSE for the CPC role is the CSE that has the most powerful VMs that are available for use. Thus, the SP may evaluate the information from each response to select at least one CPC from the plurality of common service entities. At 6, once a candidate CSE (CSE-1 in the illustrated example) is selected by the SP to take the CPC role, the SP may formally customize a role profile for CSE-1 by specifying the baseline or preferred performance requirements. Thus, the SP may generate a role profile for at least one CPC. The role profile may comprise at least one of a minimum performance requirement for a minimum performance requirement for a virtual machine of the CPC, a preferred performance time for the virtual machine of the CPC, a role migration strategy, and a role software update schedule. In an example, the role profile identifies one of the common service entities as a back-up CSE, such that the at least one CPC can migrate the role of the CPC to the back-up CSE. In another example, considering that M2M nodes may become unavailable from time to time due to periodical sleeping, the SP may select a plurality of CSEs and work out an on-duty schedule for them to each act as the CPC. Thus, the SP may select a plurality of CSF pool controllers, and the role profile may further comprise an on-duty time associated with each of the CSF pool controllers. In some cases, once the candidates are selected, the SP may begin to conduct the role assignment process described in detail below with reference to FIG. 17.

Regarding role profile generation, certain role profile templates may be defined for generating role profiles. For example, Table 1 illustrates examples data items that might be listed in an example role profile. It will be understood that other data items may be included as desired, for example, assuming the involved parties have an agreement clarifying the meanings of the date items. For example, the SP can customize a role profile for CSE-1 based on the baseline/preferred performance requirements and exception handling rules (e.g., a backup CSE that can take over the CPC role if any exception happens), which is the guideline for CSE-1 for later self-configuration.

TABLE 1
Example Role Profile Template with Example Values

| Example Data Items in | |
|---|---|
| a Role Profile Template | Example Values |
| Profile Identifier | 100203 |
| Role Name | CPC, CPMs for CSF-X instances |
| Assigned To | CSE-1 |
| Backup CSE | CSE-2 |
| Software Source for the Role | Contacts SP or a download URL |
| Minimum VM Performance | 1 vCPU (e.g., two vCPUs can |
| Requirement | share the same physical processor |
| | at 2.5 GHz), 2G RAM and 2G Storage |
| Preferred VM Performance | 2 vCPU, 4G RAM and 8G Storage |
| Requirement | |
| On-Duty Time | Daytime (8am-8pm) |
| Role Migration Strategy | Support Live Role Migration |
| Role Software Update Schedule | Every 10 days |

Referring now to FIG. 17, as an example precondition for the role assignment, the CSE-1 has been selected as the CPC (see FIG. 16), and now the SP intends to designate CSE-1 to take the role of the CPC. At 1, in accordance with the illustrated example, the SP grants the CPC role to the selected candidate CSE (CSE-1) by delivering the role profile to CSE-1. Thus, in an example, the role profile may be sent to at least one CSE of a plurality of common service entities. The role profile may inform the CSE-1 that the SP has assigned the CPC role to the CSE-1. The message at 1 may contain various data fields, at least some of which may be from the example role profile depicted in Table 1. The data fields may include, presented by way of example and without limitation:
Sender ID (s_id): The identity of the message sender informs the receiver that the message is from the SP.
Message Type (m_t): The message type may indicate the purpose of the message. For example, the receiver CSE may be informed that the SP is assigning CPC role to it from the message type.
Profile Identifier (p_i)
Role Name (optional if the receiver CSE can know this information from the m_t message)
Backup CSE (bk_cse)
Software Source for the Role (sw_source)
Minimum VM Performance Requirement (min_perf)
Preferred VM Performance Requirement (perfered_perf)
On-Duty Time (duty)
Role Migration Strategy (mig)
Role Software Update Schedule (sw_upd_time)

Still referring to FIG. 17, at 2, in accordance with the illustrated embodiment, the VPES of CSE-1 sends a response that indicates whether it accepts this role by trying to reserve the necessary VM resources as indicated in the role profile. Thus, in response to the role profile, the SP may receive an acknowledgement (ack) from at least one CSE, and the ack may indicate that the at least one CSE will begin to reserve its virtual machine resources as indicated in the role profile. In some cases, even if the CSE-1 previously indicated to the SP that it is willing to act as the CPC, it might not manage to do so. For example, certain software set-up and configurations may need to be performed as described below. Because those operations may take time, at 2, the CSE-1 may quickly indicate to SP that it agrees to meet the performance requirement as indicated in the role profile so that the SP does not initialize a new CSP, and the CSE-1 may further conduct necessary operations as mentioned above in an asynchronous fashion.

The ack message at 2 may contain various data fields, such as, for example, Response Type (r_t), which indicates whether the receiver CSE agrees to meet the performance requirement as indicated in the role profile. At 3, once getting the positive ack from the CSE-1, the SP may begin to deploy the a CPC software package to the CSE-1. The software package may enable the CSE to configure itself to be the CPC. In some cases, to act as a CPC (or a CPM), a CSE may need to run corresponding software. The VPES may be in charge of the software run. Similarly, it may be assumed that virtualization technology is utilized on M2M nodes, and therefore such a CPC software may be setup and running on a VM with the performance specification as indicated in the role profile. Alternatively, the SP may inform the CSE-1 of where to download the CPC software, for example by using a specific URI, such that the VPES of the CSE-1 may retrieve the software package from, for example, a software repository. Thus, the SP may send an indication to at least one CSE, wherein the indication enables the at least one CSE to configure itself to be the CPC. For example, the SP may optionally generate a digital certificate and assign it to the CSE-1. The certificate may contain an indication (e.g., identity of the form: cpc1.SP.com) that the CSE-1 functions as a CPC. The certificate may be a temporary certificate having a finite lifetime that may be determined based on policies. Requisition and provisioning of the certificate may be performed using public key standards, etc.

The message at 3 may contain a link data field. For example, if the role profile already included a download URL as shown in Step 1, the SP may set link=null so that the CSE can use the URL included in the role profile to download the software. Alternatively, the SP may use this data field to include the URI link to send to the receiver CSE (which may be used to dynamically direct the receiver CSE to download software in a different software repository). At 4, in accordance with the illustrated example, the CSE-1 acquires the CPC software, and the VPES of the CSE-1 is in charge of installing the CPC software and configuring the CPC software instance based on parameters indicated in the role profile. The VPES may verify the integrity and authenticity of the software before installing it. At 5, after step 4 is performed, the CPC is successfully deployed on the CSE-1, such that the CSE-1 is acting as a CPC. Accordingly, the CSE-1 may send a confirmation to the SP that indicates that the role assignment process is complete. The message at 5 may be an ack message that contains a Response Type (r_t) data field that indicates whether the receiver CSE successfully assumed the role of the CPC.

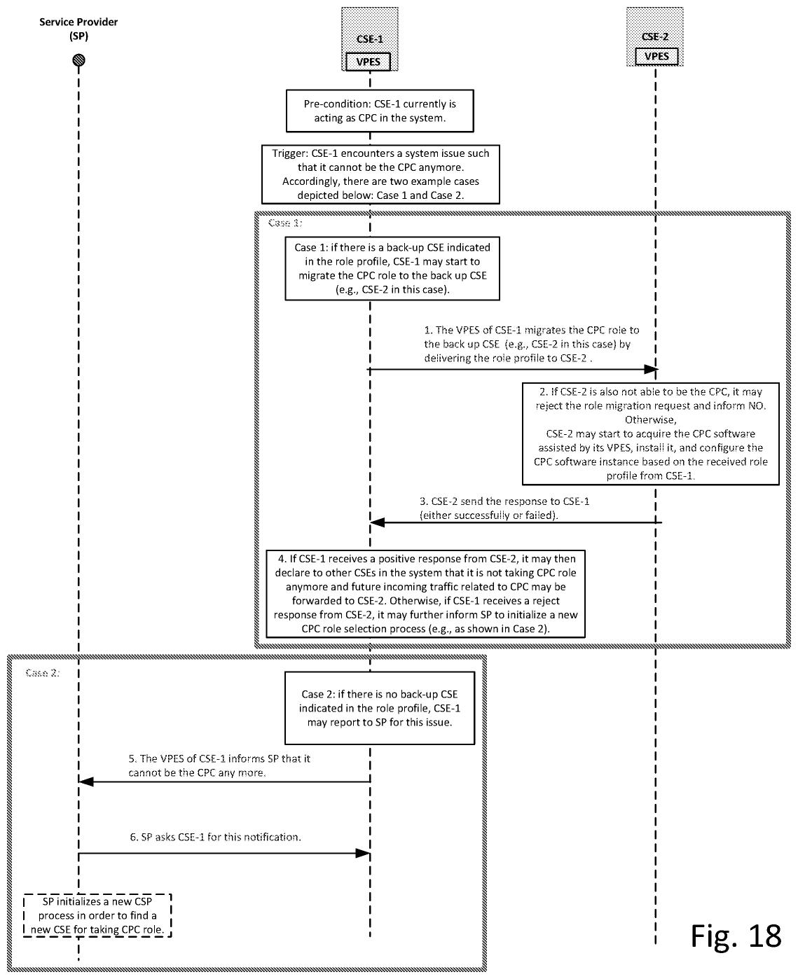

Turning now to an example role migration process (RMP) depicted by FIG. 18, the illustrated call flow assumes that the CSE-1 currently is acting as the CPC in the system. As shown, in accordance with the example, the CSE-1 encounters a system issue such that it cannot act as the CPC any longer. In one example, if there is a back-up CSE indicated in the role profile, the VPES of CSE-1 may directly start to migrate the CPC role to the backup CSE (e.g., CSE-2 in this case), as show in steps 1-4. The CSE-1 and CSE-2 may mutually authenticate one another based on credentials (e.g., certificate that was issued by SP) and may also check for authorization of the migration process.

At 1, in accordance with the illustrated example, the VPES is in charge of migrating the CPC role to the backup CSE (e.g., CSE-2 in this case) by delivering the role profile to CSE-2. As mentioned earlier, when the SP defines the role profile for CSE-1, it may already select a backup CSE for CSE-1. In this case, the VPES of CSE-1 can directly talk to the VPES of CSE-2 for role migration because the CSE-2 may have already indicated to the SP, during a CSP, that it is also willing to assume the role of the CPC. Similar to step 1 illustrated in FIG. 17, (both message are transferring a role profile), the message at 1 in FIG. 18 may contain the following date fields, presented by way of example and without limitation:
Sender ID (s_id): The identity of the message sender informs the receiver that it is from a CSE that is currently acting as the CPC.
Message Type (m_t): The message type indicates the purpose of this message. In other words, from the message type, the receiver CSE will know that the sender CSE is migrating the CPC role to it.
Profile Identifier (p_i)
Role Name (optional, for example, if the receiver CSE can determine this information from the m_t field)
Backup CSE (bk_cs) may set to null at this time, for example, if there is only one backup CSE in the original role profile.
Software Source for the Role (sw_source)
Minimum VM Performance Requirement (min_perf)
Preferred VM Performance Requirement (perfered_perf)
On-Duty Time (duty)
Role Migration Strategy (mig)
Role Software Update Schedule (sw_upd_time)

At 2, in accordance with the illustrated example, the CSE-2 is not necessarily able to really act as the CPC for completing this role migration. In particular, if the VPES of CSE-2 determines that it is not able to currently function as a CPC, it may directly reject the role migration request. Alternatively, the VPES of CSE-2 may contact the SP to download the CPC software package if it currently does not have it, or alternatively still the CSE-1 may inform the CSE-2 where to download the CPC software (e.g., via a specific URI). In addition, once the CSE-2 acquires the CPC software, it may also install it and configure the CPC software based on parameters indicated in the role profile, similar to steps 3 and 4 described with reference to FIG. 17.

During the role migration, depending on specific implementations, different features can be supported. In one example, the CSE-1 migrates the CPC role to the CSE-2 and the live CPC-related tasks managed by the CSE-1 are terminated. Alternatively, the live CPC-related tasks can also be migrated to the CSE-2 without termination.

At 3, in accordance with the illustrated example, the CSE-2 sends the response to the CSE-1 (either successful or failed as discussed with reference to 2). Similar to Step 5 as depicted in FIG. 17, the ack message at 3 may contain a Response Type (r_t) data field, which may indicate whether the receiver CSE successfully takes over the CPC role. At 4, with respect to the response received from the CSE-2, if the response indicates that the migration was successful, the CSE-2 may now act as the CPC. In particular, the CSE-1 may declare to other CSEs (e.g., those that have contacted CSE-1 in the past for CPC-related processing or operations) in the system that it is not performing the CPC role anymore and that all future incoming traffic related to the CPC role should be forwarded to the CSE-2. Alternatively, if the CSE-1 got a negative response from the CSE-2, the negative response indicates that the role migration failed. Thus, the CSE-1 may inform the SP of the failure so that the SP initializes a new CSP process, which may the same as the example illustrated in Case 2 that is now described in detail.

In example Case 2, if there is no back-up CSE indicated in the role profile, the CSE-1 may directly report this issue, as described in Steps 5-6 below. In some cases, from a security perspective, the SP may have more authority and trustworthiness. At 5, the CSE-1 informs the SP that it cannot act as the CPC anymore and no role migration can be done. Thus, the SP may receive a message from at least one CPC, wherein the message indicates that the CSE can no longer be the CPC. In response to the message, any or all of role assignment steps described above with reference to FIG. 16 and FIG. 17 may be repeated. The message at 5 may contain a Message Type (m_t) data field, which may include a value that informs the SP that the CSE cannot be the CPC anymore. At 6, the SP acknowledges the CSE-1 for this notification and initializes a new CSP. Accordingly, the response message may include a response type field (r_t) for this indication. In cases in which the CPC role is taken by a number of different CSEs in an alternative manner (e.g., based on a pre-defined on-duty schedule), the example role migration described herein can also be applied to change the CPC among a plurality of CSEs.

Turning now to CPM assignment, the example methods described above relative to assigning a CSE as a CPC can be utilized. This re-use is helpful for reducing development cycles and for developing lightweight code that can be deployed on the M2M node, especially considering that many M2M nodes are capacity constrained. In some cases, however, there are variations between assigning a CPC role and assigning a CPM role. For example, it might be necessary in some cases to not only assign the CPM role to a CSE, but also to link the CPM with the CPC such that the roles as defined in the VNF Pool architecture can be hooked together in order to work in a systematic way. Thus, the example methods described with reference to FIGS. 15-18 may be reused for CPM assignment, and a Role Linking Process (RLP) may also be performed to build the VNF Pool architecture by linking the related roles together.

Thus, in accordance with an example, the SP (or a node or apparatus generally) may send a request to a plurality of common service entities. In response to the request, the SP may receive a plurality of responses from the plurality of common service entities. Each response may include information related to whether a respective common service entity (CSE) can be a common service function (CSF) pool manager (CPM). The SP may evaluate the information from each response to select at least one CPM from the plurality of common service entities. In an example, the request queries a current capacity of each CSE and whether each CSE is willing to be the CPM. The SP may generate a role profile for the at least one CPM. The role profile may include at least one of a minimum performance requirement for a virtual machine of the CPM, a preferred performance time for the virtual machine of the CPM, a role migration strategy, and a role software update schedule. In an example, the SP may select a plurality of CSF pool managers, and the role profile may further include an on-duty time associated with each of the CSF pool managers. The SP may send the role profile to at least one CSE of the plurality of common service entities. In response to the role profile, the SP may receive an acknowledgement from the at least one CSE, and the acknowledgement may indicate that the at least one CSE will begin to reserve its virtual machine resources as indicated in the role profile. In an example, the SP may deploy a software package to the at least one CSE, wherein the package enables the at least one CSE to configure itself to be the CPM. In another example, the SP may send an indication to the at least one CSE, wherein the indication enables the at least one CSE to configure itself be the CPM.

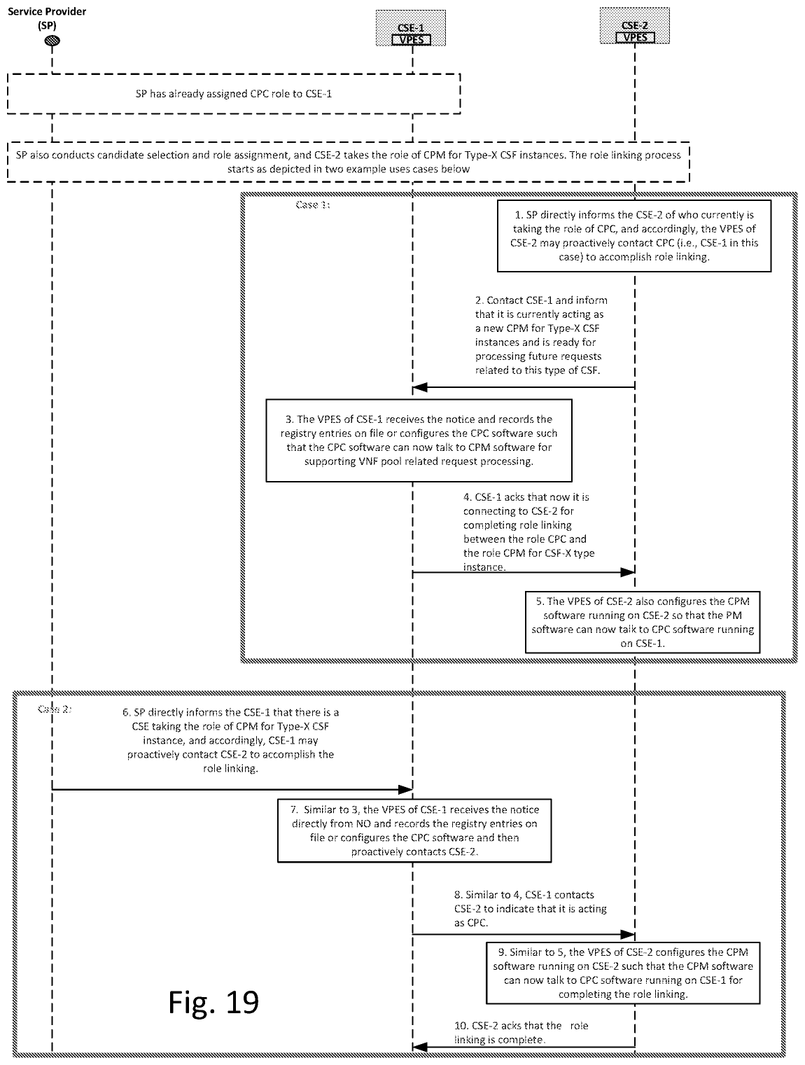

Referring to FIG. 19, in accordance with the illustrated RLP, the SP has already assigned the CPC role to the CSE-1 by using the procedures described above. In the example, the SP intends to assign a CPM role for Type-X CSF instances. In order to do this, as mentioned earlier, the previous CSP and RAP can be reused, and it is assumed for purposes of example that the CSE-2 is taking the role of CPM for the Type-X CSF instances.

In one example (Case 1), the CPM proactively contacts the CPC for completing the RLP. As shown, at 1, after the role assignment, the SP may directly inform the CSE-2 about the CSE that is currently taking the role of the CPC (e.g., CSE-1 in this case). Accordingly, the VPES of the CSE-2 may proactively contact the CPC (e.g., CSE-1 in this case) to accomplish the role linking. The message that is sent at 1 may contain various data fields, such as, for example and without limitation:
Sender ID (s_id): The identity of the message sender may inform the receiver that the message is from the SP.
Message Type (m_t): The message type indicates the purpose of the message. For example, based on the message type, the receiver CSE will know that the SP is informing the receiver CSE of the identity of the CPC.
CSE-CPC-ID (cse-cpc-id): This field may store the CSE-ID that currently is acting as the CPC.

Still referring to FIG. 19, at 2, in accordance with the illustrated example, the VPES of the CSE-2 contacts the VPES of CSE-1, and informs the CSE-1 that the CSE-2 is currently acting as a new CPM for Type-X CSF instances and is ready for processing future requests related to this type (Type-X) of CSF. In some cases, this process is like a registration, so that both nodes can know each other. At 3, the VPES of the CSE-1 receives the notice and records the registry entries on file, or configures the CPC software on the CSE-1 such that the CPC software can talk to the CPM software running on the CSE-2. For example, the messages that are sent between the CPC and the CPM, and the business logic that is supported between the CPC and CPMs, may be implemented in CPC or CPM software packages. Thus, in some cases, what remains to be done is to fill the missing information concerning who currently is taking those roles and how to communicate with each other (e.g., by exchanging their IP addresses or port numbers for communications and any other Point-of-Contact information). At 4, the VPES of the CSE-1 acknowledges (acks) that now it is connecting to the CSE-2 to complete role linking. At this point, the CSE-1 acting in the role of CPC and the CSE-2 acting in the role CPM for CSF-x type instance are now linked with each other and can work together, as defined in the VNF Pool architecture. Similar to previous acks, the ack message at 4 may contain a Response Type (r_t) data field that indicates whether the RLP process is completed at the CPC. At 5, in accordance with the illustrated example, the VPES of the CSE-2 may also need to configure the CPM software running on the CSE-2, such that the CPM software can now talk to the CPC software running on the CSE-1.

Turning now to another example (Case 2) depicted in FIG. 19, instead of triggering a CPM to contact the CPC, the SP can also inform the CPC such that the CPC can proactively contact the newly assigned/configured CPM for role linking. At 6, the SP may directly inform the CSE-1 that there is a CSE that will be taking the role of CPM for Type-X CSF instance (e.g., CSE-2 in this example case), and accordingly, the VPES of CSE-1 may proactively contact the CSE-2 to accomplish the RLP. Thus, the SP may inform at least one CSE of an identity of another CSE that is a CSF pool manager, such that the at least one CSE can contact the CSE that is the CPM. Similarly, the SP may inform at least one CSE of an identity of another CSE that is a CSF pool controller (CPC), such that the at least one CSE can contact the CSE that is the CPC. The message sent at 6 may contain the following data fields, presented by way of example and without limitation:
Sender ID (s_id): The identity of the message sender informs the receiver that the message is from the SP.
Message Type (m_t): The message type indicates the purpose of the message. For example, based on the message type data field, the receiver CSE will know that the SP is telling the receiver CSE who is currently acting as the new CPM.
CSE-CPM-ID (cse-cpc-id): This field may store the CSE-ID that currently is acting as the CPM.
CSF-Type-ID (csf-ty-id): This field may store the corresponding type of CSF instances that will be managed by the new CPM.
   At 7, similar to 3, the VPES of the CPC receives the notice directly from the SP, records the registry entries on file or configures the CPC software, and then proactively contacts the VPES of the CSE-2. At 8, similar to 4, the CSE-1 contacts that CSE-2 to inform the CSE-2 that it is now acting as the CPC. At 9, similar to 5, the VPES of the CSE-2 configures the CPM software running on the CSE-2 so that the CPM software can now talk to the CPC software running on the CSE-1, for completing the RLP. At 10, in accordance with the illustrated example, the CSE-2 acks that the RLP is complete.

Turning now to pool management, a CPM may conduct pool management. In particular, CSF software instances on different CSEs can join or leave a logical VNF pool, and can be managed by corresponding CPMs.

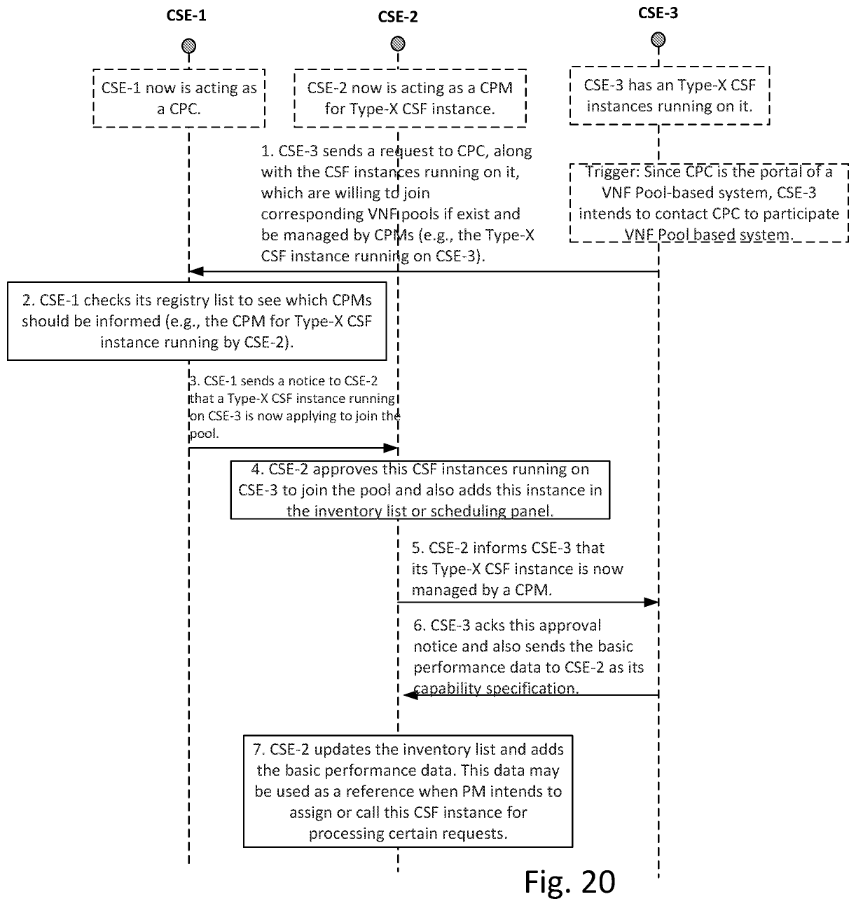

Referring to FIG. 20, in accordance with the illustrated example, a CSF software instance joins a corresponding VNF pool managed by a CPM. As shown in FIG. 20, the CSE-1 CSE-1 is acting as a CPC, the CSE-2 is acting as a CPM for Type-X CSF instances, and the CSE-3 has a Type-X CSF software instance running on its VM. Thus, in accordance with the example, a VNF Pool based Service layer has been created and certain roles have been assigned to CSEs in the network. For purposes of the example illustrated in FIG. 20, the CPC is the portal of a VNF Pool-based system, so it is assumed that the CSEs in the network are aware of the existence of the CPC. It is further assumed that there is a Type-X CSF instance running on the CSE-3, and according to its business logic, this CSF instance is willing to participate in a VNF pool and be managed by the CPM. In order to do so, CSE-3 attempts to contact the CPC, which currently is CSE-1. Alternatively, the CPM may contact different CSEs to ask whether they are hosting or running corresponding CSF instances, and to ask whether they are willing to join corresponding VNF pools.

Still referring to FIG. 20, at 1, in accordance with the illustrated embodiment, the CSE-3 sends a request to the CSE-1, along with the CSF instance list that includes CSF instances running on the CSE-3 that are willing to join one or more VNF pools (e.g., the Type-X CSF instance running on CSE-3 as shown). The request may indicate that the CSE-3 includes one or more CSF instances of a certain type that are willing to join a pool of the certain type. The message at 1 may contain the following data fields, presented by way of example and without limitation:
Sender ID (s_id): The identity of the message sender informs the receiver that the message is from a CSE.
Message Type (m_t): The message type indicates the purpose of this message. For example, from message type, the CPC will know that the sender is sending a batch of CSF instances that are willing to join the VNF pools.
CSF-instance-list (cse-cpc-id): This field stores the detailed information about each CSF instance that is willing to join a VNF pool. Information may include its CSF type, point of access, etc.
   Thus, a CPC may receive a request from a common service entity (CSE), and the request may indicate that the CSE includes one or more common service function (CSF) instances of a certain type that are willing to join a pool of the certain type.

At 2, the CPC checks its registry list to see which CPMs should be informed (e.g., the CPM for Type-X CSF instance taken by CSE-2 as shown). Thus, the CPC may determine, from the registry list, one or more CSF pool managers that should be informed of the request, wherein the one or more mangers are associated with a respective pool of the certain type. In addition, in some cases, for a given type of CSF, there might be no CPM role that has been assigned to a CSE. In this case, the CPC may directly reject this joining-pool request. At 3, in accordance with the illustrated example, the CPC sends a notice to the CSE-2 that a Type-X CSF instance running on CSE-3 is now applying to join the VNF pool for Type-X CSF. The message at 3 may contain the following data fields, presented by way of example and without limitation:
Sender ID (s_id): The identity of the message sender informs the receiver that the message is from a CPC.
Message Type (m_t): The message type indicates the purpose of this message. For example, based on the message type, the CPM will know there are new CSF instances that want to join its pool.
CSF-instance-list (cse-cpc-id): This field stores the detailed information about each CSF instance that is willing to join in the VNF pool managed by the current CPM. The information may include, for example, its CSF type, point of access, etc.
   Thus, the CPC may send a notice to at least one of one or more CSF pool managers, and the notice may indicate that one or more instances of the CSE are applying to join the respective pool managed by at least one CSF pool manager.

Still referring to FIG. 20, at 4, in accordance with the illustrated example, the CSE-2 is currently acting as the CPM for VNF Pool for Type-X CSF, and the CSE-2 approves that this CSF instance can join the pool. The CSE-2 further adds this instance in the inventory list or a scheduling plan for future use (e.g., for instance provisioning). Thus, when CSF instances are approved to join the pool, the CSF instances may be added to an inventory list for future use. At 5, the CSE-2 further informs the CSE-3 that its Type-X CSF instance is now managed by the CSE-2, which is the CPM. Thus, based on the request that it sent, the CSE-3 may receive a message that is sent from the CPM, and the message may indicate that one or more CSF instances are being managed by the CPM. At 6, the CSE-3 acks this approval notice and also sends performance data associated with the CSE-3 to the CSE-2 as its capability specification. The CSE-3 may send an ack message that includes performance data associated with the CSE-3. The ack message at 5 may contain the following data fields, presented by way of example and without limitation:
Response Type (r_t): This data field indicates that the CSF instance running on the sender CSE is ready to be managed by CPM.
Performance Data (p_d): This data field may also include some basic performance data, so that the CPM can use the data for selecting CSF instances at a later time.
   At 7, the CSE-2 may update the inventory list to add the basic performance data. This data may be used as a reference when, for example, the CPM intends to assign or call this CSF instance for processing certain service layer requests.

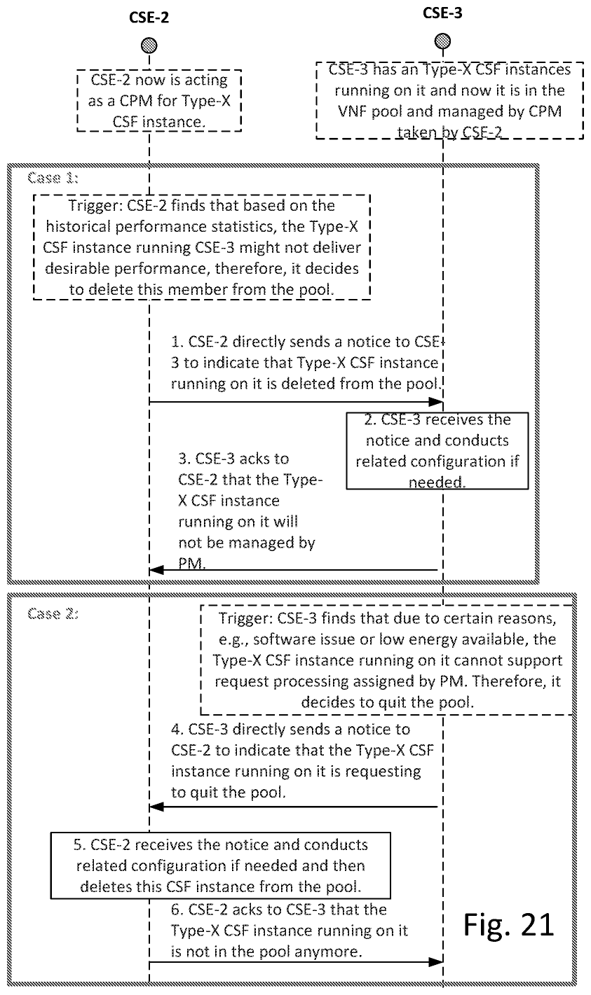

Referring now to FIG. 21, a CSF software instance leaves the pool in accordance with an example embodiment. As shown in FIG. 21, the CSE-2 is acting as the CPM for Type-X CSF instances, the CSE-3 has a Type-X CSF instance running on it, and the CSE-3 is in the VNF pool managed by the CPM (the CSE-2 in this example).

In a first example case (Case 1) the CPM initiates deleting a pool instance from the pool. For example, the CSE-2 may determine, based on historical performance statistics (or any other reason), that the Type-X CSF instance running CSE-3 cannot always deliver desirable performance. Therefore, the CSE-2 may decide to delete this member from the pool and might also not select it as a pool member in the future. It will be understood that other causes may trigger the CPM to delete a pool instance.

At 1, in accordance with the illustrated example, the CSE-2 directly sends a notice to the CSE-3 that the Type-X CSF instance running on it is going to be deleted from the pool. The message at 1 may contain the following data fields, presented by way of example and without limitation:
Sender ID (s_id): The identity of the message sender informs the receiver that the message is from a CPM.
Message Type (m_t): The message type indicates the purpose of this message. For example, based on the message type, the receiver CSE will know that this is a notice regarding a deletion of a CSF instance running on it.
CSF-instance-list (cse-cpc-id): This field stores which CSF instances running on the receiver CSE are to be deleted from the pool.
   Thus, the CSE-2 may send a delete notice to the CSE-3, and the delete notice may indicate that one or more CSF instances are being deleted from the pool. In an example, the delete notice may be sent based on one or more historical performance characteristics of the CSE-3. At 2, the CSE-3 receives the notice and may conduct related configuration (if needed). At 3, the CSE-3 acks to CSE-2 that the Type-X CSF instance running on it will not be managed by the CPM. The acknowledgement (ack) message at 3 may contain a Response Type (r_t) data field, which may indicate that the receiver CSE is already aware of the fact that one of more of the CSF instances running on it are to be deleted from the pool. Thus, the CSE-2 may receive a delete acknowledgement from the CSE-3, and the delete acknowledgement may indicate that the CSE-3 is aware that the one or more CSF instances are being deleted from the pool. In some cases, when a CSF instance leaves the pool, there may be on-going tasks being processed by the CSF instance. In one example, the CSF instance cannot leave the pool until it completes all ongoing tasks. In another example, a migration is performed.

Still referring to FIG. 21, in a second example case (Case 2), a certain CSF instance proactively proposes to quit a VNF pool. For example, as shown, the CSE-3 determines that the Type-X CSF instance running on it cannot support the request processing assigned by its CPM. Thus, the delete notice may be sent based on a determination of the CSE-2 that the CSF instances cannot support processing assigned to it. This determination may be based on various reasons, for example a software issue or low power that is available. Accordingly, the CSE-3 decides to quit the corresponding VNF pool managed by the CSE-2. At 4, in accordance with the illustrated example, the CSE-3 directly sends a notice to the CSE-2 to indicate that the Type-X CSF instance running on it is requesting to quit the pool. The message sent at 4 may contain the following data fields, presented by way of example and without limitation:
Sender ID (s_id): The identity of the message sender informs the receiver that the message is from a CSE.
Message Type (m_t): The message type indicates the purpose of the message. For example, based on the message type, the CPM will know that a CSF instance running on the sender CSE is requesting to quit from pool.
CSF-instance-list (cse-cpc-id): This field stores which CSF instances running on the receiver CSE are going to quit from pool.

At 5, in accordance with the illustrated example, the CSE-2 receives the notice and may conduct related configuration (if needed). The CSE-2 may also delete this CSF instance from the member inventory of this CPM. At 6, the CSE-2 acks to the CSE-3 that the Type-X CSF instance running on it is no longer in the pool. The ack message at 6 may contain a Response Type (r_t) data field, which may indicate whether those CSF instances are successfully deleted from the pool by the corresponding CPM.

As described above, the embodiments disclosed herein can be implemented in a oneM2M functional architecture, but can also apply beyond the M2M service layer. For example, as described above, NFV technology can be implemented to build a VNF Pool-based service layer, which includes tasks (e.g., see FIG. 15) that are beyond the service layer. For example, the CSF instances may be network function software instances as considered in NFV. In particular, the existing CSF's defined by oneM2M are assumed to be implemented as software instances running on VMs of M2M nodes. Thus, it is recognized herein that methods described above may be related to system setup by an SP, which may be considered as beyond the scope of M2M service layer.

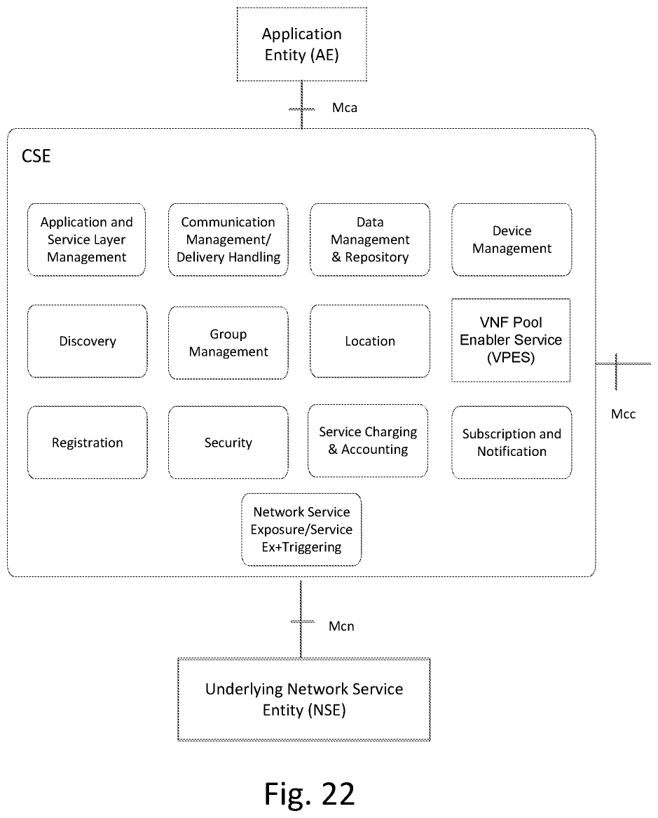

In an example, by implementing the methods described herein, CPC or CPM software may be deployed on CSEs so that they can act as a CPC or a CPM. Accordingly, a service layer request message that is received by a CSE can be further sent to the CPC or CPM for processing, instead of having to be processed by the receiver CSE itself. Thus, the embodiments described herein may impact existing mca and mcc reference points because a receiver CSE may contact another CSE (acting as the CPC) for processing a received service layer request message. Further, as described above, a VPES can be used, and therefore the VPES is defined as a new CSF in the service layer in accordance with an example embodiment, which is shown in FIG. 22.

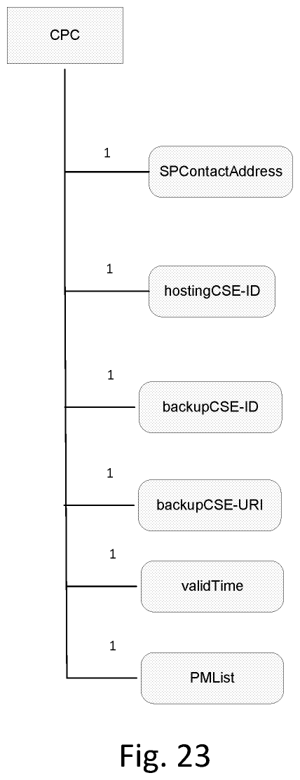

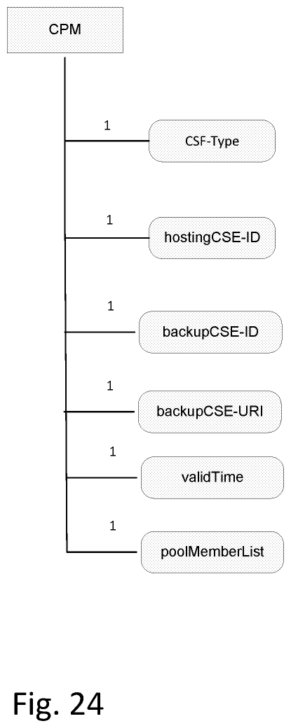

Referring now to FIGS. 23 and 24, new oneM2M resources are defined that support VNF Pool-based request processing as described above. In particular, because there are different roles defined in the VNF Pool architecture and different CSEs that can take these roles, the <CPC> resource (see FIG. 23) and the <CPM> resource (see FIG. 24) are defined in accordance with an example embodiment. Descriptions of the resource attributes of the CPC and the CPM are shown below in Table 2 and Table 3, respectively.

The oneM2M resources defined herein (see FIGS. 23 and 24) can realize the new request processing paradigm supported by Pool based service layer that is described above. For example, if a CSE receives a request from an originator, it can process this request by using CSF instances in VNF Pools by directly forwarding this request to the URI of a <CPC> resource hosted on a CSE (e.g., the one currently acting as CPC). Thus, in some cases, once a request is targeted to a <CPC> resource, the hosting CSE acting as the CPC will know that this request will be processed in compliance with VNF Pool paradigm. Next, the CPC may determine which CPMs need to be contacted to process this request, and may forward the request targeting the corresponding <CPM> resourcesa. Similarly, once a CSE acting as a CPM receives the request message, it may find appropriate CSF instances from its <poolMemberList> and allow certain CSF instances in the pool to process the request and return the result.

TABLE 2
Example Attributes of <CPC> Resource

| Attributes | Multi- | |
|---|---|---|
| of <CPC> | plicity | Description |
| NOContactAddress | 1 | This is the point-of-contact address |
| | | of Network Operator (NO), so that |
| | | if this CPC has any exception or |
| | | error, SP can be contacted. |
| hostingCSE-ID | 1 | This is the ID of CSE that is |
| | | currently acting as CPC role. |
| backupCSE-ID | 1 | This is the ID of backup CSE that can |
| | | be acting as the CPC role if the current |
| | | CSE needs to migrate CPC role. |
| backupCSE-URI | 1 | This is the URI of the backup CSE. |
| validTime | 1 | This shows when this CSE started to act |
| | | as a CPC. |
| CPMList | 1 | This is the URI list of the CSEs which |
| | | are acting as CPMs. |

TABLE 3
Attributes of <CPM> Resource

| Attributes | Multi- | |
|---|---|---|
| of <CPC> | plicity | Description |
| CSF-Type | 1 | This is the type of CSF instances |
| | | that this CPM is managing. |
| hostingCSE-ID | 1 | This is the ID of CSE that is |
| | | currently acting as CPM role. |
| backupCSE-ID | 1 | This is the ID of backup CSE that can |
| | | be acting as the CPM role if the current |
| | | CSE need to migrate the CPM role. |
| backupCSE-URI | 1 | This is the URI of the backup CSE. |
| validTime | 1 | This shows when this CSE started to |
| | | act as a CPM. |
| poolMemberList | 1 | This is the URI list of the CSF instances |
| | | that currently are managed by this CPM. |

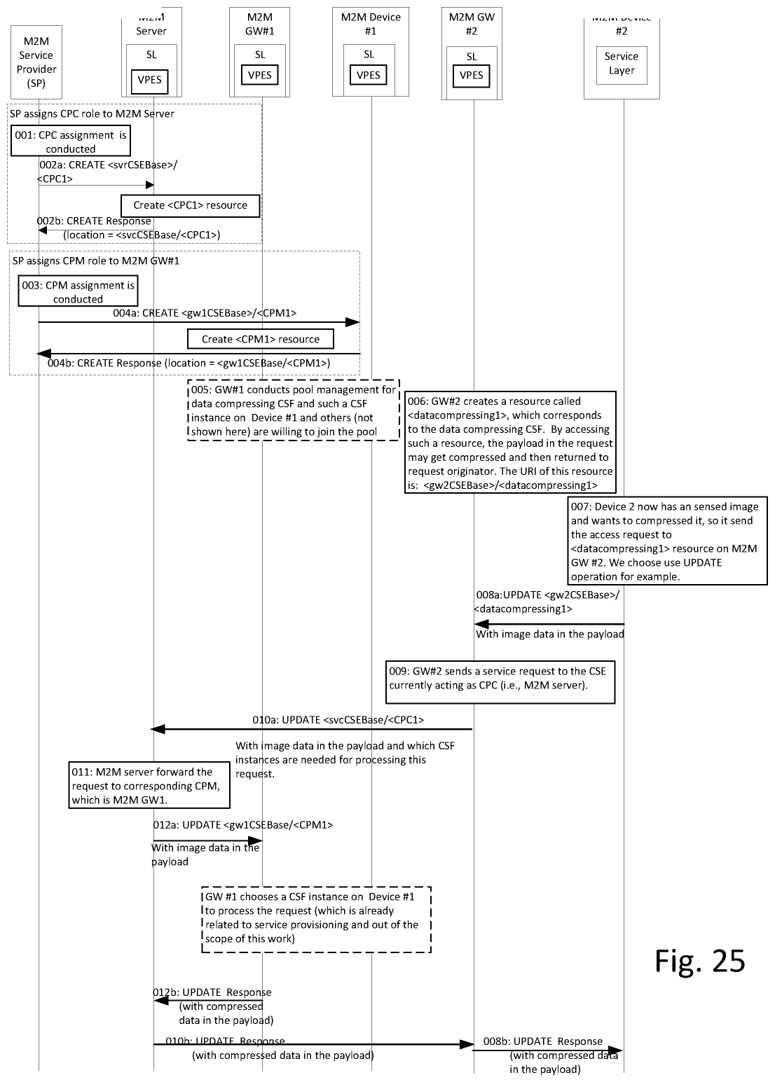

Referring now to FIG. 25, an example of how oneM2M resources shown in FIGS. 23 and 24 be used to realize the disclosed pool-based service layer is shown. The example method is performed in a system (or network) that includes an M2M SP, an M2M server, a plurality of M2M gateways (GWs), and a plurality of M2M devices. The M2M gateways include an M2M GW#1 hosting a service layer (SL) and a VPES on the SL, and an M2M GW#2 hosting an SL and a VPES on the SL. The M2M devices include an M2M device #1 hosting a SL and a VPES on the SL, and an M2M device #2 hosting a SL. It will be appreciated that the example system of FIG. 25 is simplified to facilitate description of the disclosed subject matter and is not intended to limit the scope of this disclosure. Other devices, systems, and configurations may be used to implement the embodiments disclosed herein in addition to, or instead of, a system such as the network shown in FIGS. 25, and all such embodiments are contemplated as within the scope of the present disclosure.

In this example, the first stage includes the SP assigning the CPC role to the M2M Server. At 001, in accordance with the illustrated example, the task for CPC assignment is conducted and the M2M server is selected to act as the CPC. At 002a, the SP decides to create a <CPC> resource on the M2M server and the request message is described as: CREATE <svrCSEBase>/<CPC1>. After M2M server receives the request, it may create a <CPC1> resource. In some cases, at a later time when certain CPM roles are assigned to other CSEs in the system (e.g., M2M GW#1), they will be linked with the CPC using the above-described RLP. In addition, once the M2M server start to act as a CPC, it may either proactively broadcast such information (e.g., the existence of <CPC1> resource) to the other CSEs in the network, such that the <CPC1> resource may be regarded as a service portal as defined in the existing IETF VNF Pool reference architecture. Alternatively, other CSEs may choose to discover the <CPC1> resource using the existing resource discovery approach as defined in oneM2M.

Still referring to FIG. 25, at 002b, in accordance with the illustrated example, the M2M server sends back the response, which is described as: CREATE Response (location=<svcCSEBase/<CPC1>). As shown, when the CPM role is assigned to the GW#1. At 003, the task for CPM Assignment is conducted and the GW#1 is selected to act as the CPM for a data compressing CSF. At 004a, the SP decides to create a <CPM> resource on GW#1, and the request message is described as: CREATE <gw1CSEBase>/<CPM1>. After the M2M GW#1 receives the request, it may create the <CPM1> resource. At 004b, a CREATE Response (location=<gw1CSEBase/<CPM1>) message is set to the SP. After GW#1 assumes the role of the CPM, it will start to conduct pool management. For example, at 005, as shown, the GW#1 conducts pool management for the data compressing CSF, and such a CSF instance on the Device #1 and others (not shown here) are willing to join the pool. At 006, the GW#2, which may have already discovered the <CPC1> resource using the existing resource discovery approach defined in oneM2M as mentioned above in Step 001, contacts the CPC by consulting which CSF instances can be provided in the various CSF pools. If the CPC indicated to the GW#2 that the data compressing is available, then this may trigger the GW#2 to create a resource called <datacompressing1>, which corresponds to the data compressing CSF. In some cases, such a resource may be a virtual resource in the sense that it does not include any resource representation. In the illustrated example, the URI of this resource is: <gw2CSEBase>/<datacompressing1>.

Still referring to FIG. 25, in accordance with the illustrated example, at 007, the Device #2 now has a sensed image and wants to compress it, so it sends the access request to the <datacompressing1> resource on the M2M GW #2. By way of example, an UPDATE operation may be performed. At 008a, the request message is described as: UPDATE <gw2CSEBase>/<datacompressing1>, and image data is also included in the payload. At 009, in accordance with the illustrated example, the GW#2 does not have the capability to process this request. In the meantime, because the request is targeted to the virtual resource <datacompressing1>, the GW#2 may recognize that this request needs to be processed in a pooling scheme as described herein. Accordingly, it will start to use the above-described pool-based service layer mechanisms by sending a service request to the CSE that is currently acting as the CPC (M2M server as shown). In some cases, the addressed URI will be the CPC resource, such that the M2M server will know that this request will be processed by the pool-based service layer paradigm. At 010a, the request message is described as: UPDATE <svcCSEBase/<CPC1>. This message may also include the image data in the payload, and which CSF instances are needed for processing this request. At 011, the M2M server forwards the request to the corresponding CPM, which is the M2M GW#1 in the illustrated example. At 012a, the corresponding message is described as: UPDATE <gw1CSEBase/<CPM1>, and image data is included in the payload. Once GW#1 receives the request, it may choose a CSF instance on Device #1 to process the request. At 012b, in accordance with the illustrated example, the response message is sent and the compressed data is included in the payload. At 010b, an UPDATE response may be sent (e.g., for echoing the request message in Step 010a). Similarly, at 008b, an UPDATE response is sent (for echoing the request message in Step 008a).

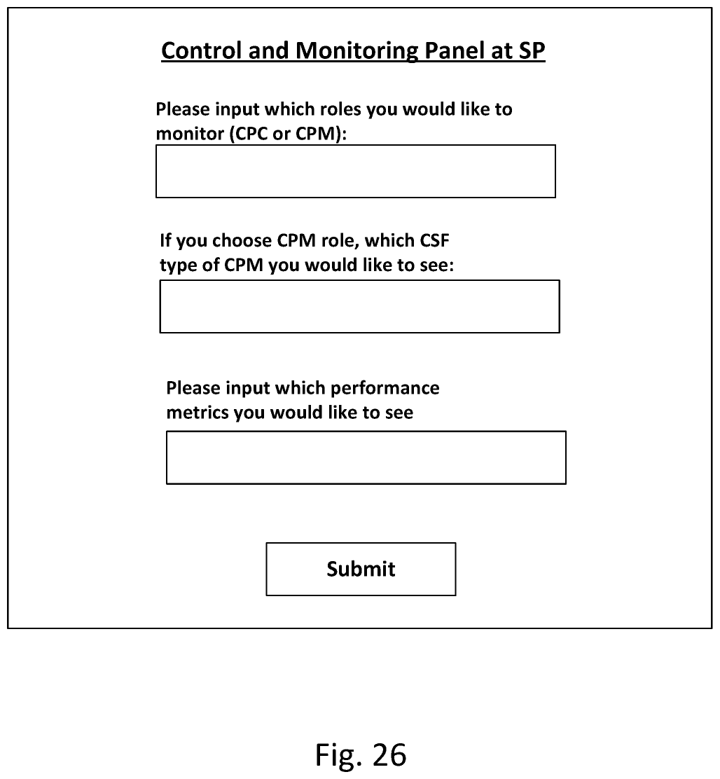

Referring now to FIG. 26, an example graphical user interface (GUI) is shown. As described above, because the SP may be responsible for assigning the roles defined herein, a GUI may allow the SP to monitor real-time statuses of different CSEs as they perform different roles. FIG. 26 depicts an example GUI for the entire system view, through which the SP can query the real-time status of different roles. For example, the SP may query a CSE that is currently acting as a CPC to determine its basic performance, how many CPMs are available in the system, how many CSF instances a given CPM is currently managing, etc. It will be understood that the GUI can be used to monitor and query alternative parameters as desired. In some cases, the queries can be input in the GUI as strings so that SP can have a system view for the network.

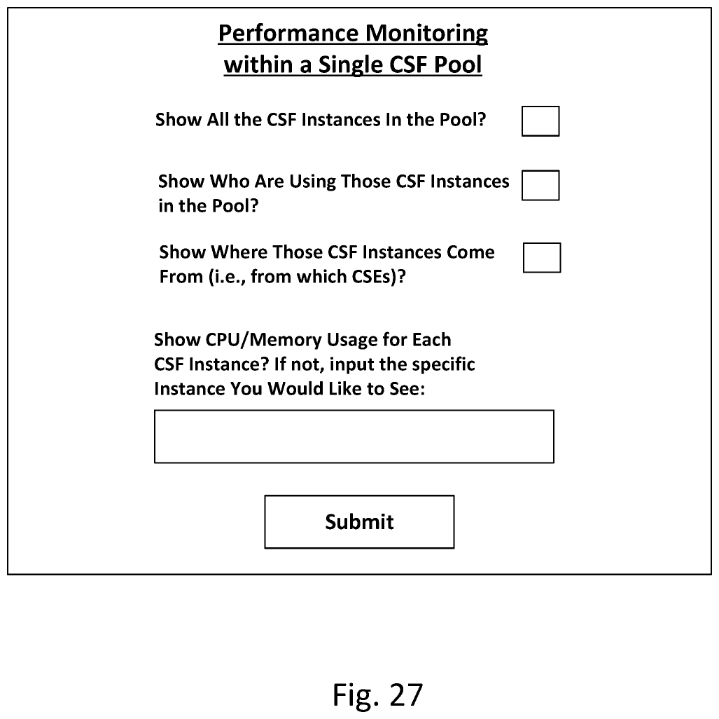

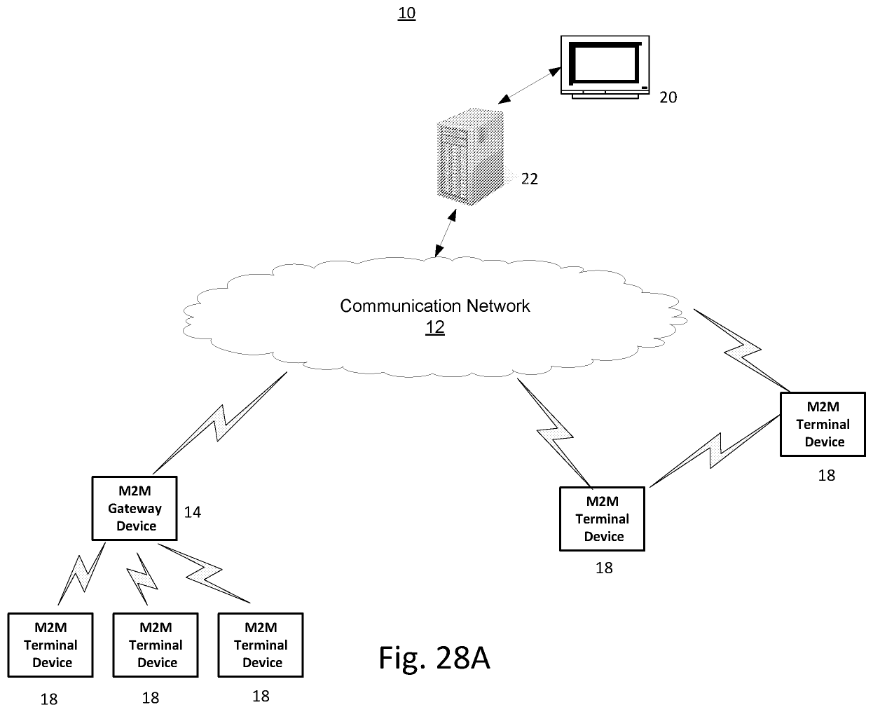

Referring now to FIG. 27, an example GUI is shown for monitoring a single CSF Pool. As shown, using this GUI, the SP may check or determine how many CSF instances are currently in the pool, who is using those CSF instances, and where those CSF pool instances are coming from (e.g. from which CSEs). It will be understood that the above examples of monitoring are not exhaustive, and the SP may make other determinations or verifications using the GUI as desired. Thus, it will be further understood that the GUIs can provide a user with various information in which the user is interested via a variety of charts or alternative visual depictions.

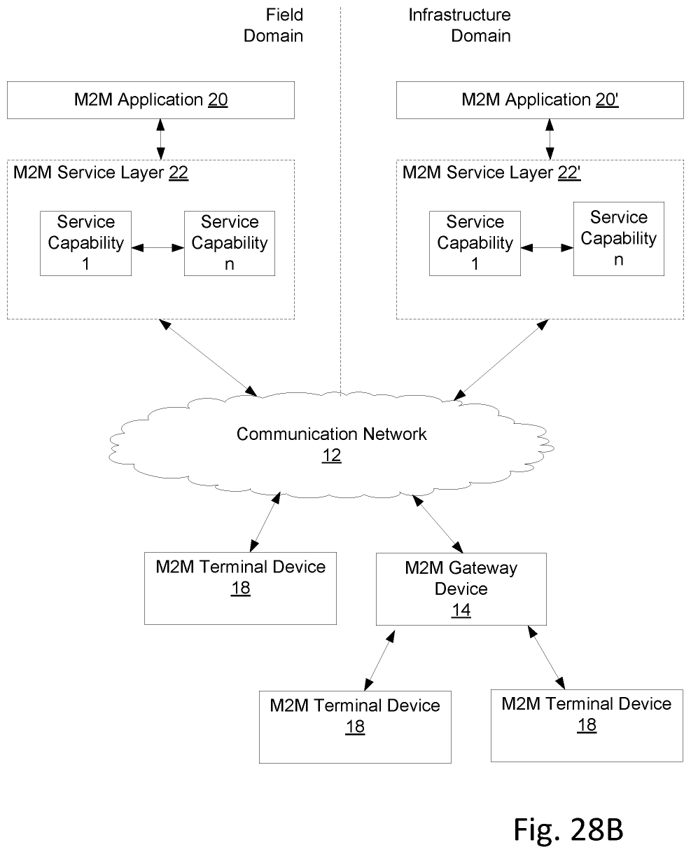

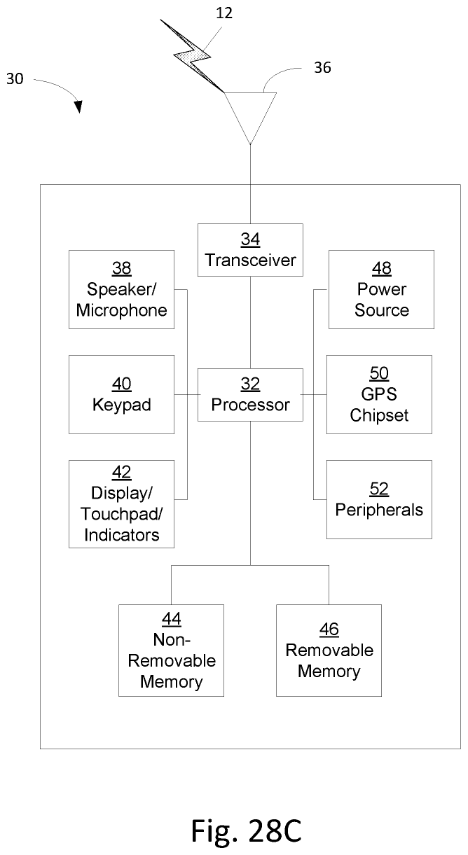

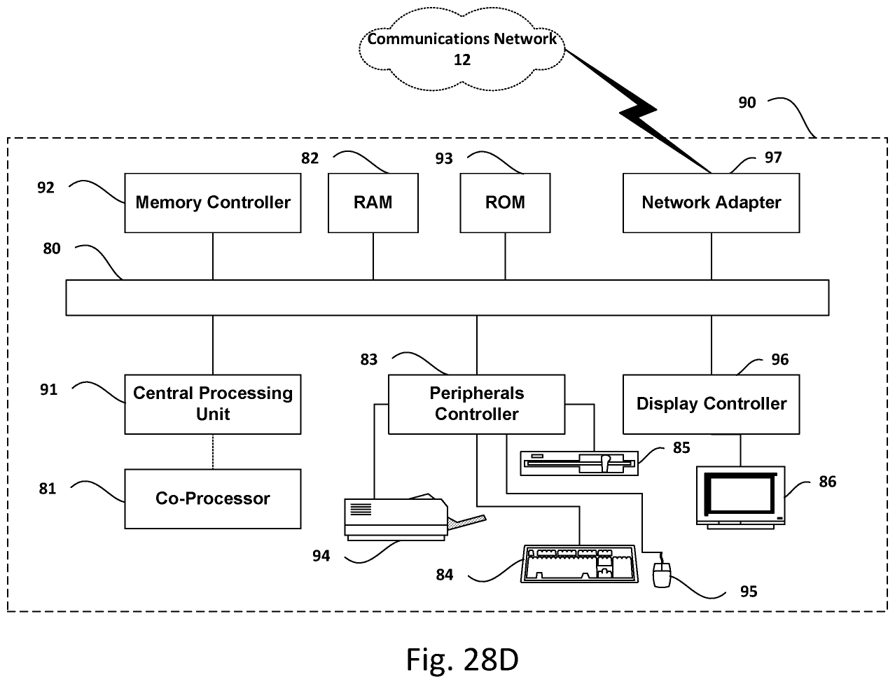

FIGS. 13-27 and the description related thereto illustrate various embodiments of methods and apparatuses for building pool-based service layers. In these figures, particularly FIGS. 15-21 and 25, various steps or operations are shown being performed by one or more nodes, devices, functions, or networks. It is understood that the nodes, devices, functions, or networks illustrated in these figures may represent logical entities in a communication network and may be implemented in the form of software (e.g., computer-executable instructions) stored in a memory of, and executing on a processor of, a node of such network, which may comprise one of the general architectures illustrated in FIG. 28A or 28B described below. That is, the methods illustrated in FIGS. 15-21 and 25 may be implemented in the form of software (e.g., computer-executable instructions) stored in a memory of a network node or apparatus, such as for example the node or computer system illustrated in FIG. 28C or 28D, which computer executable instructions, when executed by a processor of the node, perform the steps illustrated in the figures. It is also understood that any transmitting and receiving steps illustrated in these figures may be performed by communication circuitry (e.g., circuitry 34 or 97 of FIGS. 28C and 28D, respectively) of the node under control of the processor of the node and the computer-executable instructions (e.g., software) that it executes.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effect the methods described herein. As used herein, the terms “apparatus,” “network apparatus,” “node,” “device,” and “network node” may be used interchangeably.

FIG. 28A is a diagram of an example machine-to-machine (M2M), Internet of Things (IoT), or Web of Things (WoT) communication system 10 in which one or more disclosed embodiments may be implemented. Generally, M2M technologies provide building blocks for the IoT/WoT, and any M2M device, M2M gateway or M2M service platform may be a component of the IoT/WoT as well as an IoT/WoT service layer, etc. Any of the devices, functions, or nodes illustrated in any of FIGS. 13-27 may comprise a node or apparatus of a communication system, such as the ones illustrated in FIGS. 28A-D.

As shown in FIG. 28A, the M2M/IoT/WoT communication system 10 includes a communication network 12. The communication network 12 may be a fixed network (e.g., Ethernet, Fiber, ISDN, PLC, or the like) or a wireless network (e.g., WLAN, cellular, or the like) or a network of heterogeneous networks. For example, the communication network 12 may comprise multiple access networks that provides content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 28A, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain and Infrastructure Domain may both comprise a variety of different nodes (e.g., servers, gateways, devices, of the network. For example, the Field Domain may include M2M gateways 14 and terminal devices 18. It will be appreciated that any number of M2M gateway devices 14 and M2M terminal devices 18 may be included in the M2M/IoT/WoT communication system 10 as desired. Each of the M2M gateway devices 14 and M2M terminal devices 18 are configured to transmit and receive signals via the communication network 12 or direct radio link. A M2M gateway device 14 allows wireless M2M devices (e.g. cellular and non-cellular) as well as fixed network M2M devices (e.g., PLC) to communicate either through operator networks, such as the communication network 12 or direct radio link. For example, the M2M devices 18 may collect data and send the data, via the communication network 12 or direct radio link, to an M2M application 20 or M2M devices 18. The M2M devices 18 may also receive data from the M2M application 20 or an M2M device 18. Further, data and signals may be sent to and received from the M2M application 20 via an M2M service layer 22, as described below. M2M devices 18 and gateways 14 may communicate via various networks including, cellular, WLAN, WPAN (e.g., Zigbee, 6LoWPAN, Bluetooth), direct radio link, and wireline for example. Exemplary M2M devices include, but are not limited to, tablets, smart phones, medical devices, temperature and weather monitors, connected cars, smart meters, game consoles personal digital assistants, health and fitness monitors, lights, thermostats, appliances, garage doors and other actuator-based devices, security devices, and smart outlets.

Referring to FIG. 28B, the illustrated M2M service layer 22 in the field domain provides services for the M2M application 20, M2M gateway devices 14, and M2M terminal devices 18 and the communication network 12. It will be understood that the M2M service layer 22 may communicate with any number of M2M applications, M2M gateway devices 14, M2M terminal devices 18, and communication networks 12 as desired. The M2M service layer 22 may be implemented by one or more servers, computers, or the like. The M2M service layer 22 provides service capabilities that apply to M2M terminal devices 18, M2M gateway devices 14 and M2M applications 20. The functions of the M2M service layer 22 may be implemented in a variety of ways, for example as a web server, in the cellular core network, in the cloud, etc.

Similar to the illustrated M2M service layer 22, there is the M2M service layer 22′ in the Infrastructure Domain. M2M service layer 22′ provides services for the M2M application 20′ and the underlying communication network 12′ in the infrastructure domain. M2M service layer 22′ also provides services for the M2M gateway devices 14 and M2M terminal devices 18 in the field domain. It will be understood that the M2M service layer 22′ may communicate with any number of M2M applications, M2M gateway devices and M2M terminal devices. The M2M service layer 22′ may interact with a service layer by a different service provider. The M2M service layer 22′ may be implemented by one or more servers, computers, virtual machines (e.g., cloud/compute/storage farms, etc.) or the like.

Still referring to FIG. 28B, the M2M service layer 22 and 22′ provide a core set of service delivery capabilities that diverse applications and verticals can leverage. These service capabilities enable M2M applications 20 and 20′ to interact with devices and perform functions such as data collection, data analysis, device management, security, billing, service/device discovery, etc. Essentially, these service capabilities free the applications of the burden of implementing these functionalities, thus simplifying application development and reducing cost and time to market. The service layer 22 and 22′ also enables M2M applications 20 and 20′ to communicate through various networks 12 and 12′ in connection with the services that the service layer 22 and 22′ provide.

The M2M applications 20 and 20′ may include applications in various industries such as, without limitation, transportation, health and wellness, connected home, energy management, asset tracking, and security and surveillance. As mentioned above, the M2M service layer, running across the devices, gateways, and other servers of the system, supports functions such as, for example, data collection, device management, security, billing, location tracking/geofencing, device/service discovery, and legacy systems integration, and provides these functions as services to the M2M applications 20 and 20′.

Generally, a service layer (SL), such as the service layers 22 and 22′ illustrated in FIGS. 28A and 28B, defines a software middleware layer that supports value-added service capabilities through a set of application programming interfaces (APIs) and underlying networking interfaces. Both the ETSI M2M and oneM2M architectures define a service layer. ETSI M2M's service layer is referred to as the Service Capability Layer (SCL). The SCL may be implemented in a variety of different nodes of the ETSI M2M architecture. For example, an instance of the service layer may be implemented within an M2M device (where it is referred to as a device SCL (DSCL)), a gateway (where it is referred to as a gateway SCL (GSCL)) and/or a network node (where it is referred to as a network SCL (NSCL)). The oneM2M service layer supports a set of Common Service Functions (CSFs) (i.e. service capabilities). An instantiation of a set of one or more particular types of CSFs is referred to as a Common Services Entity (CSE), which can be hosted on different types of network nodes (e.g. infrastructure node, middle node, application-specific node). The Third Generation Partnership Project (3GPP) has also defined an architecture for machine-type communications (MTC). In that architecture, the service layer, and the service capabilities it provides, are implemented as part of a Service Capability Server (SCS). Whether embodied in a DSCL, GSCL, or NSCL of the ETSI M2M architecture, in a Service Capability Server (SCS) of the 3GPP MTC architecture, in a CSF or CSE of the oneM2M architecture, or in some other node of a network, an instance of the service layer may be implemented in a logical entity (e.g., software, computer-executable instructions, and the like) executing either on one or more standalone nodes in the network, including servers, computers, and other computing devices or nodes, or as part of one or more existing nodes. As an example, an instance of a service layer or component thereof may be implemented in the form of software running on a network node (e.g., server, computer, gateway, device, or the like) having the general architecture illustrated in FIG. 28C or 28D described below.

Further, the methods and functionalities described herein may be implemented as part of an M2M network that uses a Service Oriented Architecture (SOA) and/or a resource-oriented architecture (ROA) to access services, such as the above-described Network and Application Management Service for example.

FIG. 28C is a block diagram of an example hardware/software architecture of a node of a network, such as one of the nodes, devices, or functions illustrated in FIGS. 13, 15-21, and 25, which may operate as an M2M server, gateway, device, or other node in an M2M network such as that illustrated in FIG. 14, 22, 28A, or 28B. As shown in FIG. 28C, the node 30 may include a processor 32, a transceiver 34, a transmit/receive element 36, a speaker/microphone 38, a keypad 40, a display/touchpad 42, non-removable memory 44, removable memory 46, a power source 48, a global positioning system (GPS) chipset 50, and other peripherals 52. The node 30 may also include communication circuitry, such as a transceiver 34 and a transmit/receive element 36. It will be appreciated that the node 30 may include any sub-combination of the foregoing elements while remaining consistent with an embodiment. This node may be a node that implements building a pool-based M2M service layer, e.g., in relation to the methods described in FIG. 13, 15-21, and 25, or the data structures of FIGS. 23 and 24, Tables 1-3, or in a claim.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 32 may perform signal coding, data processing, power control, input/output processing, and/or any other functionality that enables the node 30 to operate in a wireless environment. The processor 32 may be coupled to the transceiver 34, which may be coupled to the transmit/receive element 36. While FIG. 28C depicts the processor 32 and the transceiver 34 as separate components, it will be appreciated that the processor 32 and the transceiver 34 may be integrated together in an electronic package or chip. The processor 32 may perform application-layer programs (e.g., browsers) and/or radio access-layer (RAN) programs and/or communications. The processor 32 may perform security operations such as authentication, security key agreement, and/or cryptographic operations, such as at the access-layer and/or application layer for example.

As shown in FIG. 28C, the processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected. In particular, the processor 32 may control the communication circuitry in order to perform the transmitting and receiving steps described herein (e.g., in FIGS. 15-22 and 25) and in the claims. While FIG. 28C depicts the processor 32 and the transceiver 34 as separate components, it will be appreciated that the processor 32 and the transceiver 34 may be integrated together in an electronic package or chip.

The transmit/receive element 36 may be configured to transmit signals to, or receive signals from, other nodes, including M2M servers, gateways, devices, and the like. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 28C as a single element, the node 30 may include any number of transmit/receive elements 36. More specifically, the node 30 may employ MIMO technology. Thus, in an embodiment, the node 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple RATs, such as UTRA and IEEE 802.11, for example.

The processor 32 may access information from, and store data in, any type of suitable memory, such as the non-removable memory 44 and/or the removable memory 46. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer. The processor 32 may be configured to control lighting patterns, images, or colors on the display or indicators 42 to reflect the status of a node or configure a node (e.g., FIGS. 26 and 27), and in particular underlying networks, applications, or other services in communication with the UE. The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the node 30. It will be appreciated that the node 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include an accelerometer, an e-compass, a satellite transceiver, a sensor, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 28D is a block diagram of an exemplary computing system 90 which may also be used to implement one or more nodes of a network, such as the nodes, devices, or illustrated in FIGS. 13, 15-21, and 25, which may operate as an M2M server, gateway, device, or other node in an M2M network such as that illustrated in FIG. 14, 22, 28A, or 28B.

Computing system 90 may comprise a computer or server and may be controlled primarily by computer readable instructions, which may be in the form of software, wherever, or by whatever means such software is stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, which performs additional functions or assists CPU 91. CPU 91 and/or coprocessor 81 may receive, generate, and process data related to the disclosed systems and methods for security protection.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adaptor 97 that may be used to connect computing system 90 to an external communications network, such as network 12 of FIG. 28A and FIG. 28B, to enable the computing system 90 to communicate with other nodes of the network. The communication circuitry, alone or in combination with the CPU 91, may be used to perform the transmitting and receiving steps described herein (e.g., in FIGS. 15-21 and 25) and in the claims.

It will be understood that any of the methods and processes described herein may be embodied in the form of computer executable instructions (i.e., program code) stored on a computer-readable storage medium which instructions, when executed by a machine, such as a computer, server, M2M terminal device, M2M gateway device, or the like, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other physical medium which can be used to store the desired information and which can be accessed by a computer.

The following is a list of acronyms relating to service technologies that may appear in the above description. Unless otherwise specified, the acronyms used herein refer to the corresponding term listed below.

| | |
|---|---|
| AE | Application Entity |
| API | Application Program Interfaces |
| ASN | Application-Specific Node |
| CapEX | Capital Expenditures |
| CPC | CSF Pool Controller |
| CPM | CSF Pool Manager |
| CSE | Common Service Entity |
| CSF | Common Service Function |
| CSP | Candidate Selection Process |
| GW | Gateway |
| IN | Infrastructure Node |
| IoT | Internet of Things |
| IT | Information Technology |
| M2M | Machine-to-Machine |
| MEC | Mobile-Edge Computing |
| MN | Middle Node |
| NF | Network Function |
| NFV | Network Functions Virtualization |
| OpEX | Operational Expenditure |
| OS | Operating System |
| RAP | Role Assignment Process |
| REST | Representational State Transfer |
| RLP | Role Linking Process |
| RMP | Role Migration Process |
| ROA | Resource-oriented Architecture |
| SOA | Service-oriented Architecture |
| URI | Uniform Resource Identifier |
| VM | Virtual Machine |
| VPES | VNF Pool Enabler Service |

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1. An apparatus comprising a processor, a memory, and communication circuitry, the apparatus being connected to a machine-to-machine (M2M) network via its communication circuitry, the apparatus further comprising computer-executable instructions stored in the memory of the apparatus which, when executed by the processor of the apparatus, cause the apparatus to perform operations comprising:
sending a request to a plurality of common service entities;
in response to the request, receiving a plurality of responses from the plurality of common service entities, each response including information related to whether a respective common service entity (CSE) can be a common service function (CSF) pool controller (CPC); and
evaluating the information from each response to select at least one CPC from the plurality of common service entities.

2. The apparatus as recited in claim 1, wherein the request queries a current capacity of each CSE and whether each CSE is willing to be the CPC.

3. The apparatus as recited in claim 1, the apparatus further comprising instructions that cause the node to perform further operations comprising:
generating a role profile for the at least one CPC, the role profile comprising at least one of a minimum performance requirement for a virtual machine of the CPC, a preferred performance time for the virtual machine of the CPC, a role migration strategy, and a role software update schedule.

4. The apparatus as recited in claim 3, wherein the apparatus selects a plurality of CSF pool controllers, the role profile further comprising an on-duty time associated with each of the CSF pool controllers.

5. The apparatus as recited in claim 3, the apparatus further comprising instructions that cause the apparatus to perform further operations comprising:
sending the role profile to at least one CSE of the plurality of common service entities.

6. The apparatus as recited in claim 5, the apparatus further comprising instructions that cause the apparatus to perform further operations comprising:
in response to the role profile, receiving an acknowledgement from the at least one CSE, the acknowledgement indicating that the at least one CSE will begin to reserve its virtual machine resources as indicated in the role profile.

7. The apparatus as recited in claim 6, the apparatus further comprising instructions that cause the apparatus to perform further operations comprising:
deploying a software package to the at least one CSE, wherein the package enables the at least one CSE to configure itself to be the CPC.

8. The apparatus as recited in claim 6, the apparatus further comprising instructions that cause the apparatus to perform further operations comprising:
sending an indication to the at least one CSE, wherein the indication enables the at least one CSE to configure itself to be the CPC.

9. The apparatus as recited in claim 7, wherein the role profile identifies one of the common service entities as a back-up CSE, such that the at least one CPC can migrate the role of the CPC to the back-up CSE.

10-21. (canceled)

22. An apparatus comprising a processor, a memory, and communication circuitry, the apparatus being connected to a machine-to-machine (M2M) network via its communication circuitry, the apparatus further comprising computer-executable instructions stored in the memory of the apparatus which, when executed by the processor of the apparatus, cause the apparatus to perform operations comprising:
sending a request to a common service function (CSF) pool controller (CPC), the request indicating that the apparatus includes one or more CSF instances of a certain type that are willing to join a pool of the certain type; and
based on the request, receiving a message from a CSF pool manager (CPM), the message indicating that the one or more CSF instances are being managed by the CPM.

23. The apparatus as recited in claim 22, the apparatus further comprising instructions that cause the apparatus to perform further operations comprising:
in response to the message, sending an acknowledgment message that comprises performance data associated with the apparatus.

24. An apparatus comprising a processor, a memory, and communication circuitry, the apparatus being connected to a machine-to-machine (M2M) network via its communication circuitry, the apparatus further comprising computer-executable instructions stored in the memory of the apparatus which, when executed by the processor of the apparatus, cause the apparatus to perform operations comprising:
receiving a notice from a common service function (CSF) pool controller (CPC), the notice indicating that one or more CSF instances of a common service entity (CSE) are applying to join a pool managed by the apparatus; and
when the one or more CSF instances are approved to join the pool, adding the one or more CSF instances to an inventory list for future use.

25. The apparatus as recited in claim 24, the apparatus further comprising instructions that cause the apparatus to perform further operations comprising:
sending a message to the CSE, the message indicating that the one or more CSF instances are being managed by the apparatus.

26. The apparatus as recited in claim 25, the apparatus further comprising instructions that cause the apparatus to perform further operations comprising:
in response to the message sent to the CSE, receiving an acknowledgment message, from the CSE, wherein the acknowledgement message comprises performance data associated with the CSE.

27. The apparatus as recited in claim 26, the apparatus further comprising instructions that cause the apparatus to perform further operations comprising:
updating the inventory list to include the performance data associated with the CSE, such that the performance data can be referred to when the apparatus intends to assign or call the one or more CSF instances for processing a service layer request.

28. The apparatus as recited in claim 24, the apparatus further comprising instructions that cause the apparatus to perform further operations comprising:
sending a delete notice to the CSE, the delete notice indicating that the one or more CSF instances are being deleted from the pool.

29. The apparatus as recited in claim 28, wherein the delete notice is sent based on one or more historical performance statistics of the CSE.

30. The apparatus as recited in claim 28, the apparatus further comprising instructions that cause the apparatus to perform further operations comprising:
receiving a delete acknowledgement from the CSE, the delete acknowledgement indicating that the CSE is aware that the one or more CSF instances are being deleted from the pool.

31. The apparatus as recited in claim 24, the apparatus further comprising instructions that cause the apparatus to perform further operations comprising:
receiving a delete notice from the CSE, the delete notice indicating that the one or more CSF instances are requesting to quit the pool.

32. The apparatus as recited in claim 31, wherein the delete notice is sent based on a determination of the CSE that the one or more CSF instances cannot support processing assigned to it.

33. (canceled)
